(19) United States
(12) Patent Application Publication
(10) Pub. No.: US 2025/0292728 A1
(43) Pub. Date: Sep. 18, 2025

(54) DISPLAY PANEL AND DISPLAY APPARATUS

(71) Applicant: TIANMA ADVANCED DISPLAY TECHNOLOGY INSTITUTE (XIAMEN) CO., LTD., Xiamen (CN)

(72) Inventors: Zhenyu JIA, Xiamen (CN); Wenxin JIANG, Xiamen (CN); Yingteng ZHAI, Xiamen (CN); Xueling LI, Xiamen (CN)

(21) Appl. No.: 19/225,637

(22) Filed: Jun. 2, 2025

(30) Foreign Application Priority Data
Jan. 7, 2025 (CN) 202510024642.3

(51) Int. Cl. G09G 3/32

(52) U.S. Cl. CPC G09G 3/32; G09G 2300/0426; G09G 2320/0633; G09G 2320/064

(57) ABSTRACT

Provided are a display panel and a display apparatus. The display panel includes: a substrate; and a driving circuit and a first output line located on one side of the substrate, where at least part of the first output line extends along a first direction; the driving circuit includes a plurality of driving units disposed in cascade, the driving units are arranged along a second direction intersecting with the first direction; at least one of the driving units includes a first output terminal and an output module, the first output line is connected to the first output terminal of the driving unit at a current stage, the output module includes a first capacitor electrically connected to the first output terminal; and along a direction perpendicular to a plane of the substrate, the first output line at least partially overlaps with at least one electrode plate of the first capacitor.

### CROSS-REFERENCE TO RELATED APPLICATION

The present application claims priority to Chinese Application No. 202510024642.3 with the application title of “DISPLAY PANEL AND DISPLAY APPARATUS”, filed on Jan. 7, 2025, the content of which is incorporated herein by reference in its entirety.

### TECHNICAL FIELD

The present disclosure relates to the field of display technologies, and in particular, to a display panel and a display apparatus.

### BACKGROUND

In order to control a pixel driving circuit in a display panel, it is necessary to provide a driving circuit for providing a control signal to the pixel driving circuit in the display panel, as well as a plurality of traces connected to the driving circuit. At present, the driving circuit and the traces occupy a relatively large space in the display panel, which restricts the improvement of the visual effect of the display panel.

### SUMMARY

Embodiments of the present disclosure provide a display panel and a display apparatus, which are used to reduce the total area occupied by a driving circuit and a first output line in the display panel.

In a first aspect, an embodiment of the present disclosure provide a display panel including:
a substrate; and
a driving circuit and a first output line located on one side of the substrate, where
at least part of the first output line extends along a first direction;
the driving circuit includes a plurality of driving units disposed in cascade, the plurality of driving units are arranged along a second direction, and the second direction intersects with the first direction;
at least one driving unit of the driving units includes a first output terminal and an output module, the first output line is connected to the first output terminal of the driving unit at a current stage, the output module includes a first capacitor, and the first capacitor is electrically connected to the first output terminal; and
along a direction perpendicular to a plane of the substrate, the first output line at least partially overlaps with at least one electrode plate of the first capacitor.

In a second aspect, an embodiment of the present disclosure provide a display apparatus including:
a substrate; and
a driving circuit and a first output line located on one side of the substrate, wherein
at least part of the first output line extends along a first direction;
the driving circuit comprises a plurality of driving units disposed in cascade, the plurality of driving units are arranged along a second direction, and the second direction intersects with the first direction;
at least one driving unit of the driving units comprises a first output terminal and an output module, the first output line is connected to the first output terminal of the driving unit at a current stage, the output module comprises a first capacitor, and the first capacitor is electrically connected to the first output terminal; and
along a direction perpendicular to a plane of the substrate, the first output line at least partially overlaps with at least one electrode plate of the first capacitor.

### BRIEF DESCRIPTION OF DRAWINGS

In order to more clearly illustrate the technical solutions of the embodiments of the present disclosure, the drawings required to be used in the embodiments will be briefly introduced. Apparently, the drawings in the following description are only some embodiments of the present disclosure. For those of ordinary skill in the art, other drawings can also be obtained from these drawings without creative efforts.

FIG. 1 is a schematic top view of a display panel provided by an embodiment of the present disclosure;

FIG. 2 is a schematic diagram of a connection relationship between a driving circuit and a pixel circuit provided by an embodiment of the present disclosure;

FIG. 3 is a schematic circuit diagram of a driving unit provided by an embodiment of the present disclosure;

FIG. 4 is a schematic diagram the wiring of a first output line and a driving unit provided by an embodiment of the present disclosure;

FIG. 5 is another schematic diagram of the wiring of a first output line and a driving unit provided by an embodiment of the present disclosure;

FIG. 6 is a schematic diagram of a pixel circuit provided by an embodiment of the present disclosure;

FIG. 7 is an operating timing diagram of a driving unit provided by an embodiment of the present disclosure;

FIG. 8 is an operating timing diagram of another driving unit provided by an embodiment of the present disclosure;

FIG. 9 is an enlarged schematic diagram of an area E1 in FIG. 4;

FIG. 10 is a schematic cross-sectional diagram taken along B1-B1′ in FIG. 9.

FIG. 11 is a further schematic diagram of the wiring of a driving unit and a first output line provided by an embodiment of the present disclosure;

FIG. 12 is an enlarged schematic diagram of an area E2 in FIG. 11;

FIG. 13 is a schematic cross-sectional diagram taken along B2-B2′ in FIG. 12;

FIG. 14 is an enlarged schematic diagram of a first connection portion and a first capacitor provided by an embodiment of the present disclosure;

FIG. 15 is a schematic cross-sectional diagram taken along B00-B00′ in FIG. 14;

FIG. 16 is a simplified schematic diagram of the distribution of three via holes in FIG. 14;

FIG. 17 is another enlarged schematic diagram of a first connection portion and a first capacitor provided by an embodiment of the present disclosure;

FIG. 18 is a schematic cross-sectional diagram taken along B0-B0′ in FIG. 17;

FIG. 19 is a schematic diagram of a first output line in FIG. 9;

FIG. 20 is a further enlarged schematic diagram of a first connection portion and a first capacitor provided by an embodiment of the present disclosure;

FIG. 21 is a schematic diagram of a first output line in FIG. 20;

FIG. 22 is a schematic cross-sectional diagram taken along B3-B3′ in FIG. 9;

FIG. 23 is a schematic cross-sectional diagram taken along B4-B4′ in of FIG. 9;

FIG. 24 is an enlarged schematic diagram of an area E3 in FIG. 4;

FIG. 25 is a schematic cross-sectional diagram taken along B5-B5′ in FIG. 24;

FIG. 26 is an enlarged schematic diagram of an area E4 in FIG. 24;

FIG. 27 is a schematic cross-sectional diagram taken along B6-B6′ in FIG. 26;

FIG. 28 is a schematic cross-sectional diagram taken along B7-B7′ in FIG. 26;

FIG. 29 is a partial schematic diagram of the wiring of a further driving unit provided by an embodiment of the present disclosure;

FIG. 30 is a schematic cross-sectional diagram taken along B8-B8′ in FIG. 29;

FIG. 31 is an enlarged schematic diagram of an area E5 in FIG. 29;

FIG. 32 is an enlarged schematic diagram of an area E6 in FIG. 4;

FIG. 33 is a schematic cross-sectional diagram taken along B10-B10′ in FIG. 32;

FIG. 34 is a schematic cross-sectional diagram taken along B11-B11′ in FIG. 32; and

FIG. 35 is a schematic diagram of a display apparatus provided by an embodiment of the present disclosure.

### DESCRIPTION OF EMBODIMENTS

In order to better understand the technical solutions of the present disclosure, the embodiments of the present disclosure are described in detail below in conjunction with the accompanying drawings.

It should be clear that the described embodiments are only a part of the embodiments of the present disclosure, not all of the embodiments. Based on the embodiments of the present disclosure, all other embodiments obtained by those of ordinary skill in the art without creative efforts shall fall within the protection scope of the present disclosure.

The terms used in the embodiments of the present disclosure are only for the purpose of describing specific embodiments and are not intended to limit the present disclosure. The singular forms “a/an”, “the” and “said” used in the embodiments of the present disclosure and the appended claims are also intended to include the plural forms, unless the context clearly indicates otherwise.

It should be understood that the term “and/or” used herein is only an association relationship describing associated objects, indicating that there can be three relationships. For example, “A and/or B” can indicate: A exists alone, A and B exist simultaneously, or B exists alone. In addition, the character “/” herein generally indicates that the associated objects before and after the character are in an “or” relationship.

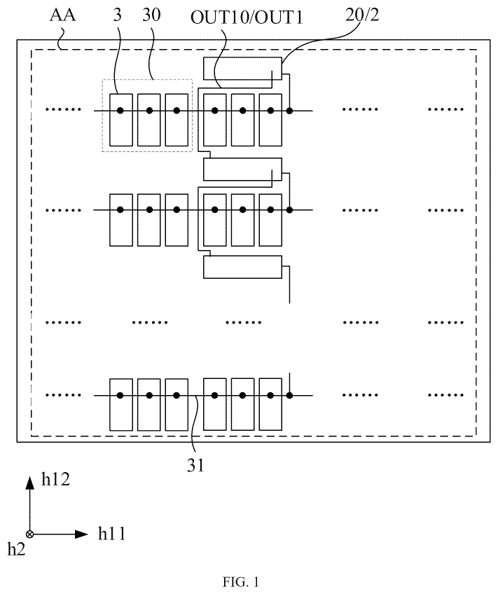

Embodiments of the present disclosure provide a display panel. As shown in FIG. 1, which is a schematic diagram of a display panel provided by an embodiment of the present disclosure, the display panel includes a substrate 1, as well as a driving circuit 2, a light-emitting element (not shown in FIG. 1) and a pixel circuit 3 which are located on one side of the substrate 1.

The pixel circuit 3 is electrically connected to the light-emitting element. The pixel circuit 3 is configured to provide a driving current to the light-emitting element to drive the light-emitting element to emit light. As an example, the light-emitting element includes any one of a micro light-emitting diode (Micro-LED), a mini light-emitting diode (Mini-LED), and an organic light-emitting diode (OLED).

In the embodiment of the present disclosure, the driving circuit 2 is configured to provide a first control signal to the pixel circuit 3 to control the on and off of a corresponding transistor in the pixel circuit 3. As shown in FIG. 1, the display panel further includes a scanning control line 31, and the driving circuit 2 provides the first control signal to the pixel circuit 3 through the scanning control line 31.

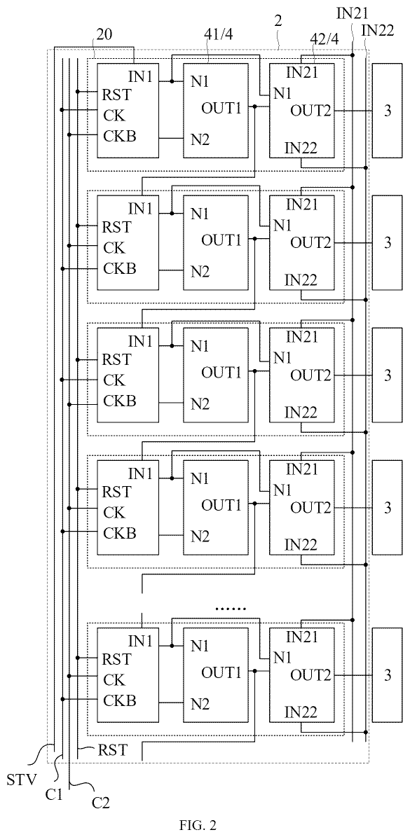

As an example, as shown in FIG. 1 and FIG. 2, where FIG. 2 is a schematic diagram of a connection relationship between a driving circuit and a pixel circuit provided by an embodiment of the present disclosure, the driving circuit 2 includes N driving units 20, where N≥2 and Nis an integer. A plurality of driving units 20 are configured to output the first control signal to a corresponding pixel circuit 3 stage by stage.

In conjunction with FIG. 2 and FIG. 3, where FIG. 3 is a schematic circuit diagram of a driving unit provided by an embodiment of the present disclosure, the driving unit 20 includes a first input terminal IN1 and a first output terminal OUT1. Optionally, the first input terminal IN1 is configured to receive a first input signal, and the first output terminal OUT1 is configured to output a first output signal. In the driving circuit 2, the plurality of driving units 20 are disposed in cascade. That is, the first output terminal OUT1 of the i-th stage driving unit 20_i is electrically connected to the first input terminal IN1 of the (i+1)-th stage driving unit 20_i+1. That is to say, for two adjacent stages of driving units 20, the first output terminal OUT1 of the previous stage driving unit 20 is electrically connected to the first input terminal IN1 of the next stage driving unit 20.

It should be noted that, as shown in FIG. 2, for the first stage driving unit 20 in the driving circuit 2, its first input terminal IN1 can be electrically connected to a start signal line STV to receive a start signal. For the last stage driving unit 20_N in the driving circuit 2, its first output terminal OUT1 can be connected to a corresponding pixel circuit 3 and is not electrically connected to another driving unit 20.

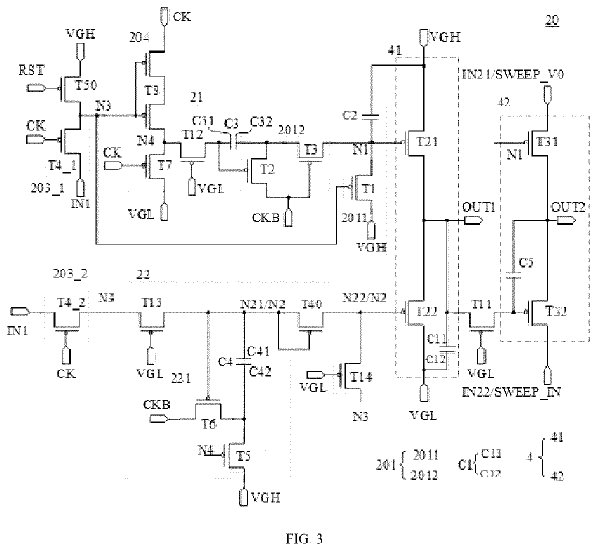

As an example, as shown in FIG. 4, which is a schematic diagram of the wiring of a driving unit provided by an embodiment of the present disclosure, the display panel further includes a plurality of first output lines OUT1 (in order to more clearly illustrate the connection relationship between each trace and the corresponding signal terminal in the driving unit, the same reference numerals are used in the embodiments of the present disclosure to mark the corresponding signal lines and corresponding signal terminals. For example, both the first output line and the first output terminal are represented by OUT1). The first output line OUT1 is electrically connected to the first output terminal OUT1 of the driving unit 20 at a current stage. Taking the driving circuit 2 including N driving units 20 cascaded as an example, the display panel may include N first output lines OUT1, where the N first output lines OUT1 are electrically connected to the first output terminals OUT1 of the N driving units 20 in a one-to-one correspondence. The driving unit 20 at the current stage that corresponds to the first output line OUT1 is the driving unit 20 among the plurality of driving units 20 whose first output terminal OUT1 is connected to the first output line OUT1.

As an example, as shown in FIG. 1 and FIG. 4, at least part of the first output line OUT1 extends along a first direction h11, and the plurality of driving units 20 are arranged along a second direction h12 that intersects with the first direction h11.

As an example, as shown in FIG. 1 and FIG. 4, the first output line OUT1 includes a main body portion OUT10, and the main body portion OUT10 and the driving unit 20 are arranged along the second direction h12. Along the second direction h12, the main body portion OUT10 is located on one side of the driving unit 20 at the current stage close to the next stage driving unit 20. Optionally, as shown in FIG. 4, at least part of the main body portion OUT10 can extend along the first direction h11. FIG. 1 and FIG. 4 illustrate that the first direction h11 and the second direction h12 are perpendicular. Alternatively, the first direction h11 can also be an extension directions of another part of the first output line OUT1 that does not extend along the second direction h12. The embodiments of the present disclosure does not limit an included angle between the first direction h11 and the second direction h12.

In conjunction with FIG. 2, FIG. 3 and FIG. 4, the driving unit 20 further includes an output module 4.

As shown in FIG. 3 and FIG. 4, the output module 4 includes a first capacitor C1. The first capacitor C1 is electrically connected to the first output terminal OUT1, and the first capacitor C1 can improve the potential stability of the first output signal output by the first output terminal OUT1. In particular, as shown in FIG. 3, the first capacitor C1 includes a first electrode plate C11 and a second electrode plate C12. The first electrode plate C11 of the first capacitor C1 is electrically connected to the first output terminal OUT1, and the second electrode plate C12 is electrically connected to a second level signal terminal VGL.

When disposing the first output line OUT1 and the first capacitor C1, as an example, as shown in FIG. 4, along a direction h2 perpendicular to a plane of the substrate 1, the first output line OUT1 can be made at least partially overlap with at least one electrode plate of the first capacitor C1 in the embodiments of the present disclosure. Based on this configuration, compared with the configuration in which the first output line OUT1 and both electrode plates of the first capacitor C1 are staggered in the direction h2 perpendicular to the plane of the substrate 1, the total area occupied by the first output line OUT1 and the first capacitor C1 in the display panel can be reduced. In conjunction with FIG. 5, which is another schematic diagram of the wiring of a driving unit provided by an embodiment of the present disclosure, the first output line OUT1 and the first capacitor C1 do not overlap each other in the direction h2 perpendicular to the plane of the substrate 1. As shown in FIG. 5, the first output line OUT1 includes a first portion 101 extending along the second direction h12, and at least part of the first portion 101 and the first capacitor C1 are arranged along the first direction h11. Compared with FIG. 5, the configuration shown in FIG. 4 can compress a length d1 of the driving unit 20 in the first direction h11.

As shown in FIG. 2 and FIG. 3, the driving unit 20 further includes a first control signal output terminal OUT2. The first control signal output terminal OUT2 is configured to output the above-mentioned first control signal under the control of the first output terminal OUT1. The pixel circuit 3 is configured to receive the first control signal and generate the driving current under the control of the first control signal to drive the light-emitting element to emit light.

Optionally, in conjunction with FIG. 2, FIG. 3, FIG. 4 and FIG. 5, the output module 4 includes a first output module 41 and a second output module 42. The first output module 41 is electrically connected to the above-mentioned first output terminal OUT1, and the second output module 42 is electrically connected to the above-mentioned first control signal output terminal OUT2. As shown in FIG. 3, the first output module 41 electrically connects the first output terminal OUT1 and a first level signal terminal VGH in response to a signal of a first node N1, and electrically connects the first output terminal OUT1 and the second level signal terminal VGL in response to a signal of a second node N2. The second output module 42 electrically connects the first control signal output terminal OUT2 and a first control signal input terminal IN21 in response to a signal of the first node N1, and electrically connects the first control signal output terminal OUT2 and a second control signal input terminal IN22 in response to a signal of the first output terminal OUT1.

Optionally, as shown in FIG. 3, the first output module 41 includes a first output transistor T21 and a third output transistor T22. The first output transistor T21 has a gate electrically connected to the first node N1, as well as a first terminal and a second terminal electrically connected to the first level signal terminal VGH and the first output terminal OUT1 respectively. The third output transistor T22 has a gate electrically connected to the second node N2, as well as a first terminal and a second terminal electrically connected to the second level signal terminal VGL and the first output terminal OUT1 respectively.

As an example, as shown in FIG. 3, the second output module 42 includes a second output transistor T31 and a fourth output transistor T32. The second output transistor T31 has a gate electrically connected to the first node N1, a first terminal is electrically connected to the first control signal input terminal IN21, and a second terminal is electrically connected to the first control signal output terminal OUT2. The fourth output transistor T32 has a gate electrically connected to the first output terminal OUT1, and a first terminal and a second terminal are electrically connected to the second control signal input terminal IN22 and the first control signal output terminal OUT2 respectively.

Optionally, as shown in FIG. 3, the driving unit 20 further includes a first processing module 21 electrically connected to the first node N1 and a second processing module 22 electrically connected to the second node N2. When the driving unit 20 operates, the first processing module 21 and the second processing module 22 are configured to write signals to the first node N1 and the second node N2 respectively. When the first node N1 is written with an enable level, the third output transistor T22 is turned on, and a second level signal provided by the second level signal terminal VGL can be written into the first output terminal OUT1. Under the control of the first output terminal OUT1, the fourth output transistor T32 is turned on, and a signal provided by the second control signal input terminal IN22 can be written into the first control signal output terminal OUT2 through the turned-on fourth output transistor T32, so that the first control signal output terminal OUT2 outputs the first control signal, and this first control signal is provided to a corresponding pixel circuit 3.

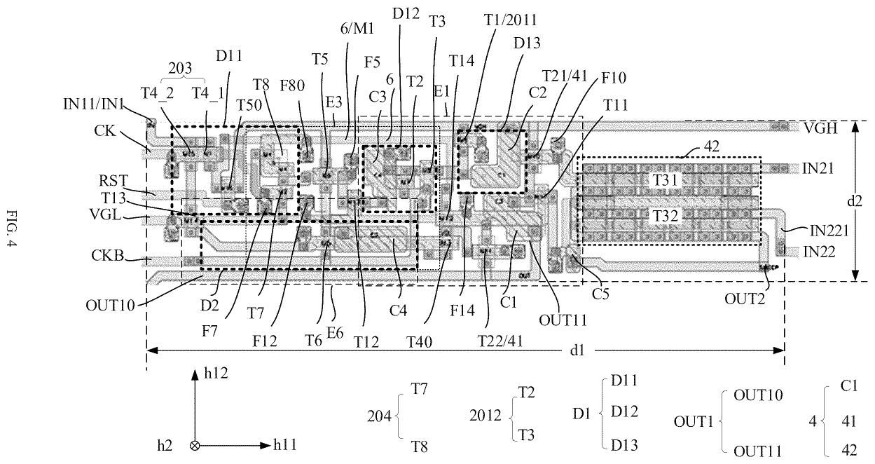

Optionally, as shown in FIG. 6, which is a schematic diagram of a pixel circuit provided by an embodiment of the present disclosure, the pixel circuit 3 includes a pulse width modulation module 10 and a pulse amplitude modulation module 20. The pulse width modulation module 10 receives a sweep signal SWEEP to control a duration for which a light-emitting driving current is provided to a light-emitting element 12, thereby controlling a light-emitting duration of the light-emitting element 12 and thus realizing the adjustment of the brightness of the light emitted by the light-emitting element 12. The pulse amplitude modulation module 20 is configured to provide the light-emitting driving current to the light-emitting element 12 and control the light-emitting efficiency of the light-emitting element 12 by adjusting the amplitude of the light-emitting driving current. Based on this configuration, the light-emitting element 12 can operate under an appropriate driving current, which is beneficial for the light-emitting element 12 to achieve higher light-emitting efficiency and better display effect.

Optionally, as shown in FIG. 6, the pulse amplitude modulation module 20 may include a first light-emitting control transistor T021, a first driving transistor Td1, a second light-emitting control transistor T022, a pulse amplitude data writing transistor T023, a pulse amplitude compensation transistor T024, a pulse amplitude gate reset transistor T025, a pulse amplitude anode reset transistor T026, and a first storage capacitor Cst1.

The first light-emitting control transistor T021 has a first terminal electrically connected to a first power supply line PAM_PVDD and a second terminal electrically connected to a first terminal of the first driving transistor Td1.

The second light-emitting control transistor T022 has a first terminal electrically connected to a second terminal of the first driving transistor Td1 and a second terminal electrically connected to a first terminal of the light-emitting element 12.

A gate of the first light-emitting control transistor T021 and a gate of the second light-emitting control transistor T022 receive a pulse amplitude light-emitting control signal provided by a pulse amplitude light-emitting control signal terminal PAM_EM.

The pulse amplitude data writing transistor T023 has a first terminal electrically connected to a first data signal line PAM_DATA and a second terminal electrically connected to the first terminal of the first driving transistor Td1.

The pulse amplitude compensation transistor T024 has a first terminal electrically connected to the second terminal of the first driving transistor Td1 and a second terminal electrically connected to a gate of the first driving transistor Td1.

The pulse amplitude gate reset transistor T025 has a first terminal electrically connected to a first reset signal line PAM_REF and a second terminal electrically connected to the gate of the first driving transistor Td1.

The pulse amplitude anode reset transistor T026 has a first terminal electrically connected to a third power supply line PVEE and a second terminal electrically connected to the first terminal of the light-emitting element 12.

A gate of the pulse amplitude gate reset transistor T025 receives a first scan signal provided by a first scan signal line PAM_S1, and gates of the pulse amplitude data writing transistor T023, the pulse amplitude compensation transistor T024, and the pulse amplitude anode reset transistor T026 receive a second scan signal provided by a second scan signal line PAM_S2.

Continuing to refer to FIG. 6, the pulse width modulation module 10 may include a third light-emitting control transistor T031, a pulse width data writing transistor T032, a second driving transistor Td2, a pulse width compensation transistor T033, a pulse width gate reset transistor T034, a fourth light-emitting control transistor T035, and a second storage capacitor Cst2.

The third light-emitting control transistor T031 has a first terminal electrically connected to the second power supply line PWM_PVDD and a second terminal electrically connected to a first terminal of the second driving transistor Td2.

The fourth light-emitting control transistor T035 has a first terminal electrically connected to a second terminal of the second driving transistor Td2 and a second terminal electrically connected to the gate of the first driving transistor Td1 in the pulse amplitude modulation module 20.

The pulse width data writing transistor T032 has first terminal electrically connected to a second data signal line PWM_DATA and a second terminal electrically connected to the first terminal of the second driving transistor Td2.

The pulse width compensation transistor T033 has a first terminal electrically connected to the second terminal of the second driving transistor Td2 and a second terminal electrically connected to a gate of the second driving transistor Td2.

The pulse width gate reset transistor T034 has a first terminal electrically connected to a second reset signal line PWM_REF and a second terminal electrically connected to the gate of the second driving transistor Td2.

The second storage capacitor Cst2 has one electrode plate electrically connected to the gate of the second driving transistor Td2 and the other electrode plate electrically connected to a sweep signal terminal SWEEP.

Gates of the third light-emitting control transistor T031 and the fourth light-emitting control transistor T035 are electrically connected to a pulse width light-emitting control signal line PWM_EM to receive a pulse width light-emitting control signal provided by the pulse width light-emitting control signal line PWM_EM.

A gate of the pulse width gate reset transistor T034 is electrically connected to a third scan signal line PWM_S1 to receive a third scan signal provided by the third scan signal line PWM_S1.

Gates of the pulse width data writing transistor T032 and the pulse width compensation transistor T033 are electrically connected to a fourth scan signal line PWM_S2 to receive a fourth scan signal provided by the fourth scan signal line PWM_S2.

When the pixel circuit 3 operates, a reference voltage (such as a voltage on the second power supply line PWM_PVDD) is set at the first terminal of the second driving transistor Td2 of the pulse width modulation module 10, and a changing potential is formed at the gate of the second driving transistor Td2 through a data voltage on the second data signal line PWM_DATA and the sweep signal at the sweep signal terminal SWEEP. When a voltage difference between the gate and the first terminal of the second driving transistor Td2 is greater than a threshold voltage of the second driving transistor Td2, the second driving transistor Td2 is in a cut-off state, so that the pulse width modulation module 10 does not provide a control signal to the pulse amplitude modulation module 20, and the first driving transistor Td1 in the pulse amplitude modulation module 20 provides the light-emitting driving current to the light-emitting element 12 according to a voltage on the first data signal line PAM_DATA.

As the voltage of the signal transmitted by the sweep signal terminal SWEEP changes, the potential of the gate of the second driving transistor Td2 changes synchronously. Until the voltage difference between the gate and the first terminal of the second driving transistor Td2 is equal to (or less than) the threshold voltage of the second driving transistor Td2, the second driving transistor Td2 is turned on. The second driving transistor Td2 transmits the voltage on the second power supply line PWM_PVDD as a cut-off voltage to the pulse amplitude modulation module 20, so that the first driving transistor Td1 in the pulse amplitude modulation module 20 is turned off, thereby stopping providing the light-emitting driving current to the light-emitting element 12. It can be seen that the pulse width modulation module 10 can control the duration of the light-emitting driving current output by the pulse amplitude modulation module 20, so as to adjust the effective light-emitting duration of the light-emitting element 12 within one frame time, and in turn adjust the light-emitting brightness of the light-emitting element 12.

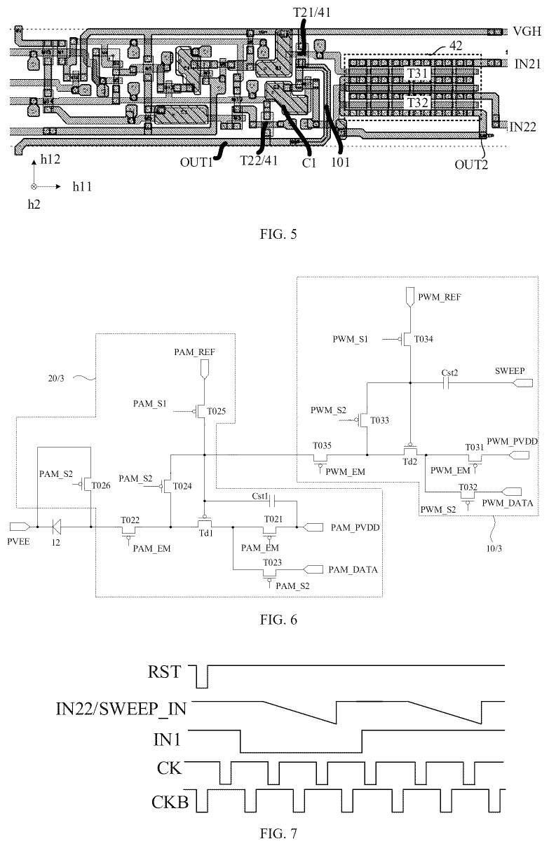

As an example, the first control signal output by the above-mentioned driving unit 20 includes the sweep signal SWEEP. That is, the first control signal output terminal OUT2 of the driving circuit can be electrically connected to the sweep signal terminal SWEEP of the pixel circuit 3 shown in FIG. 6. The first control signal input terminal IN21 includes a constant signal terminal. As an example, this constant signal terminal can be configured to transmit a constant high level or a constant low level. The second control signal input terminal IN22 includes a sweep input signal terminal SWEEP_IN. As an example, as shown in FIG. 7, which is an operating timing diagram of a driving unit provided by an embodiment of the present disclosure, the sweep input signal terminal SWEEP_IN is configured to transmit a triangular ramp signal. Optionally, this triangular ramp signal can be a signal whose level gradually increases over time, or this triangular ramp signal can be a signal whose level gradually decreases over time, which is not limited in the embodiments of the present disclosure.

Alternatively, the first control signal output by the above-mentioned driving unit 20 can also include the pulse amplitude light-emitting control signal PAM_EM. That is, the first control signal output terminal OUT2 of the driving circuit can be electrically connected to the pulse amplitude light-emitting control signal terminal PAM_EM of the pixel circuit 3 shown in FIG. 4. The first control signal input terminal IN21 includes a constant signal terminal. As an example, this constant signal terminal can be configured to transmit a constant high level or a constant low level. The second control signal input terminal IN22 includes a pulse amplitude light-emitting control signal input terminal PAM_EM_IN. As an example, as shown in FIG. 8, which is an operating timing diagram of a driving unit provided by an embodiment of the present disclosure, the pulse amplitude light-emitting control signal input terminal PAM_EM_IN is configured to transmit a square wave signal.

It should be noted that the circuit structure of the pixel circuit 3 shown in FIG. 6 is merely a schematic illustration. The structure of the pixel circuit 3 provided in the embodiment of the present disclosure is not limited to thereto, and the embodiments of the present disclosure do not specifically limit the structure of the pixel circuit 3.

As an example, as shown in FIG. 4, the display panel further includes a second level signal connection line VGL (using the same mark as the second level signal terminal) and a first level signal connection line VGH (using the same mark as the first level signal terminal). At least part of the second level signal connection line VGL and at least part of the first level signal connection line VGH both extend along the first direction h11. Moreover, along the second direction h12, at least part of the second level signal connection line VGL is located between the first level signal connection line VGH and the main body portion OUT10 of the above-mentioned first output line OUT1.

When the first output transistor T21 and the third output transistor T22 are disposed, as an example, as shown in FIG. 4, along the second direction h12, the first output transistor T21 can be located on one side of the first capacitor C1 close to the first level signal connection line VGH. Based on this configuration, a distance between the first output transistor T21 and the first level signal connection line VGH can be shortened, which can facilitate the connection between the first terminal of the first output transistor T21 and the first level signal connection line VGH.

As an example, as shown in FIG. 4, along the second direction h12, at least part of the third output transistor T22 can be located on one side of the above-mentioned first capacitor C1 away from the first output transistor T21, so as to shorten a distance between the third output transistor T22 and the second level signal line VGL, which facilitates the connection between the third output transistor T22 and the second level signal connection line VGL.

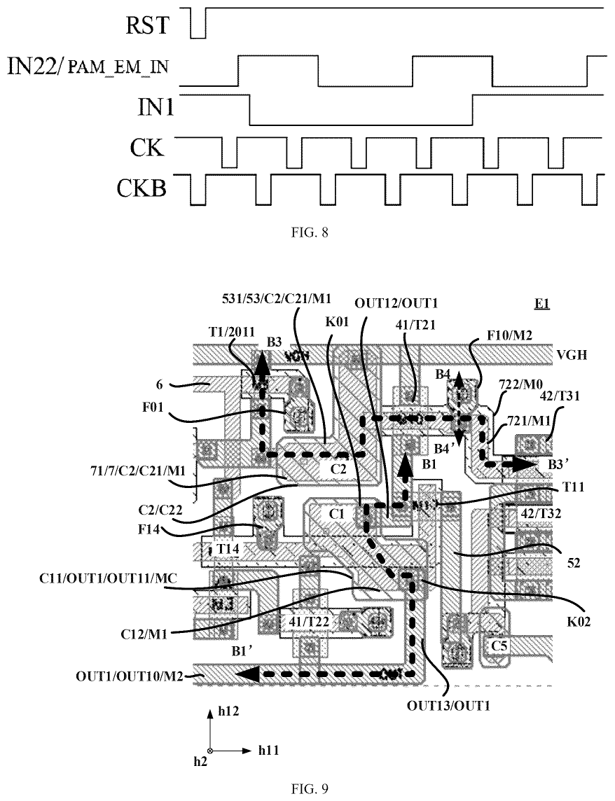

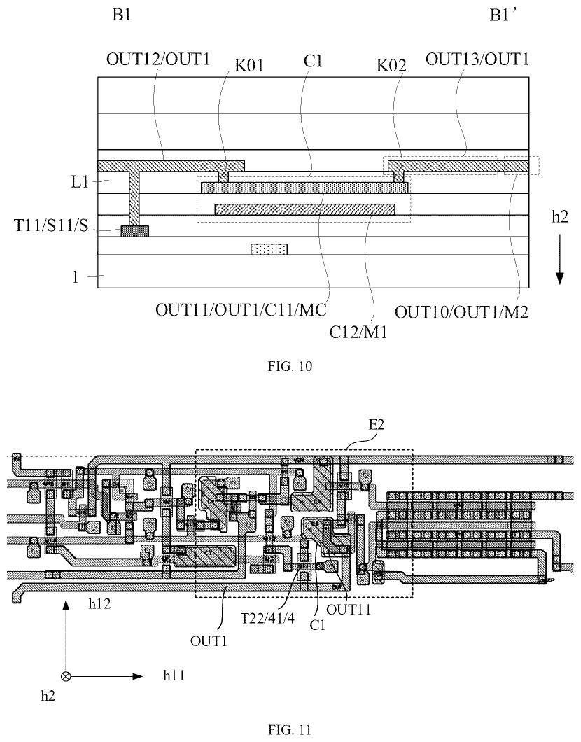

As an example, as shown in FIG. 4, FIG. 9 and FIG. 10, where FIG. 9 is an enlarged schematic diagram of an area E1 in FIG. 4, and FIG. 10 is a schematic cross-sectional diagram taken along B1-B1′ in FIG. 9, the first output line OUT1 includes a first connection portion OUT11 and a main body portion OUT10 which are connected to each other. Along the direction h2 perpendicular to the plane of the substrate 1, the first connection portion OUT11 overlaps with at least one electrode plate of the first capacitor C1. Moreover, the first connection portion OUT11 is located on one side of the at least one electrode plate of the first capacitor C1 away from the substrate 1.

As an example, as shown in FIG. 10, the display panel includes a semiconductor layer S, a first gate metal layer M1, a capacitor metal layer MC and a source-drain metal layer M2. The first gate metal layer M1 is located on one side of the semiconductor layer S away from the substrate 1, the capacitor metal layer MC is located on one side of the first gate metal layer M1 away from the semiconductor layer S, and the source-drain metal layer M2 is located on one side of the capacitor metal layer MC away from the first gate metal layer M1.

As an example, the first electrode plate C11 of the first capacitor C1 can be located on one side of the second electrode plate C12 away from the substrate 1. FIG. 10 illustrates that the capacitor metal layer MC includes the first electrode plate C11 of the first capacitor C1, and the first gate metal layer M1 includes the second electrode plate C12 of the first capacitor C1.

Optionally, in the embodiments of the present disclosure, the first connection portion OUT11 can be located on the side of the second electrode plate C12 of the first capacitor C1 away from the substrate 1. For example, in the embodiments of the present disclosure, the first connection portion OUT11 and the first electrode plate C11 of the first capacitor C1 can be disposed in a same layer, or the first connection portion OUT11 can be located on one side of the first electrode plate C11 of the first capacitor C1 away from the substrate 1. The film layer position of the first connection portion OUT11 will be described in detail below, and will not be elaborated at this moment here. FIG. 10 illustrates that the first connection portion OUT11 and the first electrode plate C11 of the first capacitor C1 are disposed in the same layer in the capacitor metal layer MC.

In the embodiments of the present disclosure, by making the first connection portion OUT11 at least partially overlap with at least one electrode plate of the first capacitor C1 in the direction h2 perpendicular to the plane of the substrate 1, the total area occupied by the first connection portion OUT11 and the first capacitor C1 in the display panel can be reduced, which is beneficial to compressing the area occupied by the driving circuit 2 in the display panel.

In the embodiments of the present disclosure, as shown in FIG. 9, the second terminal of the first output transistor T21 and the second terminal of the third output transistor T22 are connected at least through the above-mentioned first connection portion OUT11.

Optionally, as shown in FIG. 9, in addition to the above-mentioned first connection portion OUT11 and main body portion OUT10, the first output line OUT1 also includes a first connection sub-portion OUT12 and a second connection sub-portion OUT13. Along the direction h2 perpendicular to the plane of the substrate 1, the first connection sub-portion OUT12 and the two electrode plates of the first capacitor C1 are at least partially non-overlapping each other, and the second connection sub-portion OUT13 and the two electrode plates of the first capacitor C1 are at least partially non-overlapping each other.

As an example, as shown in FIG. 9, the second terminal of the first output transistor T21 can be connected to the first electrode plate C11 of the first capacitor C1 through the first connection sub-portion OUT12, and the second terminal of the third output transistor T22 can be connected to the first electrode plate C11 of the first capacitor C1 through the second connection sub-portion OUT13.

As an example, in the embodiments of the present disclosure, at least part of the first electrode plate C11 of the first capacitor C1 can be reused as the above-mentioned first connection portion OUT11. As shown in FIG. 9 and FIG. 10, in the embodiments of the present disclosure, the first connection portion OUT11 can be located in the capacitor metal layer MC. That is, the first connection portion OUT11 is located on the side of the second electrode plate C12 of the first capacitor C1 away from the substrate 1. Based on this configuration, it is equivalent that the first electrode plate C11 of the first capacitor C1 together with the above-mentioned first connection sub-portion OUT12 and the second connection sub-portion OUT13 form a connection structure connecting the second terminal of the first output transistor T21 and the second terminal of the third output transistor T22. While realizing the electrical connection between the second terminal of the first output transistor T21 and the second terminal of the third output transistor T22, there is no need to additionally provide a connection structure, which is beneficial to simplifying the wiring structure of the driving unit 20.

As an example, as shown in FIG. 10, along the direction h2 perpendicular to the plane of the substrate 1, the first connection sub-portion OUT12 and the second connection sub-portion OUT13 can be located on one side of the first capacitor C1 away from the substrate 1.

Optionally, as shown in FIG. 9 and FIG. 10, in the embodiments of the present disclosure, the first connection portion OUT11 can be connected to the first connection sub-portion OUT12 through a via hole K01, and the first connection portion OUT11 can be connected to the second connection sub-portion OUT13 through another via hole K02.

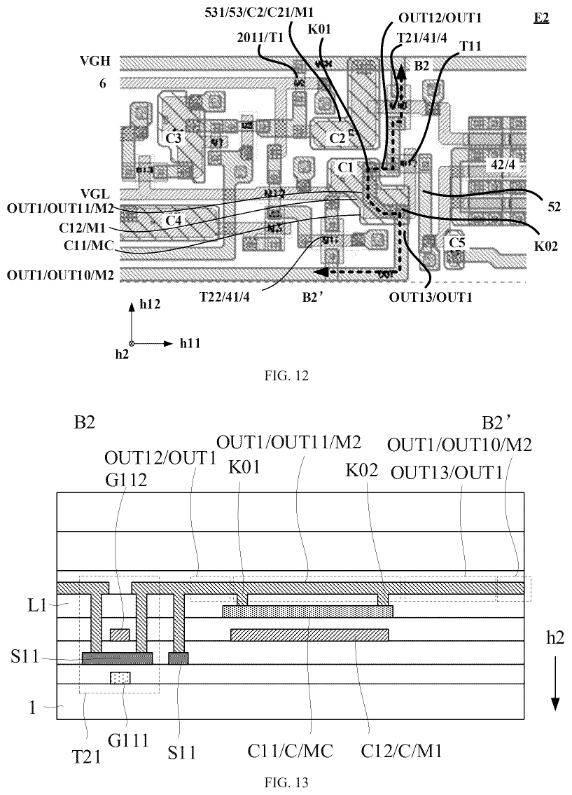

In another optional implementation, in the embodiments of the present disclosure, at least part of the first connection portion OUT11 can also be located on the side of the first electrode plate C11 of the first capacitor C1 away from the substrate 1. As shown in FIG. 11, FIG. 12 and FIG. 13, where FIG. 11 is a further schematic diagram of the wiring of a driving unit provided by an embodiment of the present disclosure, FIG. 12 is an enlarged schematic diagram of an area E2 in FIG. 11, and FIG. 13 is a schematic cross-sectional diagram taken along B2-B2′ in FIG. 12, it is illustrated that at least part of the first connection portion OUT11 is included in the source-drain metal layer M2. Based on this configuration, the disposing freedom of the first connection portion OUT11 can be increased. For example, a material with a higher electrical conductivity can be selected to form the first connection portion OUT11, which is beneficial to reducing the resistance of the first connection portion OUT11, and in turn reducing the delay of the first output signal transmitted by the first connection portion OUT11 during its transmission process. When at least part of the first connection portion OUT11 is located on the side of the first electrode plate C11 of the first capacitor C1 away from the substrate 1, the first connection portion OUT11 is electrically connected to the first electrode plate C11 of the first capacitor C1 through a via hole.

As an example, in the embodiments of the present disclosure, the first connection portion OUT11 can be electrically connected to the first electrode plate C11 of the first capacitor C1 through at least two via holes, and two via holes of the at least two via holes are spaced apart from each other. As shown in FIG. 12 and FIG. 13, the first connection portion OUT11 has one end electrically connected to the first electrode plate C11 of the first capacitor C1 through the via hole K01 and the other end electrically connected to the first electrode plate C11 of the first capacitor C1 through the via hole K02. Based on this configuration, it is equivalent that the first connection portion OUT11 is connected in parallel with the first electrode plate C11, which is beneficial to further reducing the resistance of the first output line OUT1.

As an example, as shown in FIG. 13, the first connection portion OUT11 can be in a same layer as and directly connected to the above-mentioned first connection sub-portion OUT12, and can be in a same layer as and directly connected to the above-mentioned second connection sub-portion OUT13. The above-mentioned via hole K01 connects not only the second terminal of the first output transistor T21 and the first electrode plate C11 of the first capacitor C1, but also the first connection portion OUT11 and the first electrode plate C11 of the first capacitor C1. The via hole K02 is configured to connect not only the second terminal of the third output transistor T22 and the first electrode plate C11 of the first capacitor C1, but also the first connection portion OUT11 and the first electrode plate C11 of the first capacitor C1.

As shown in FIG. 13, a first insulating layer L1 is incorporated between the capacitor metal layer MC and the source-drain metal layer M2, and the above-mentioned via hole K01 and via hole K02 penetrate the first insulating layer L1.

FIG. 12 and FIG. 13 illustrate that the first connection portion OUT11 is electrically connected to the first electrode plate C11 of the first capacitor C1 through two via holes. Of course, the first connection portion OUT11 and the first electrode plate C11 of the first capacitor C1 can be electrically connected through a larger number of via holes.

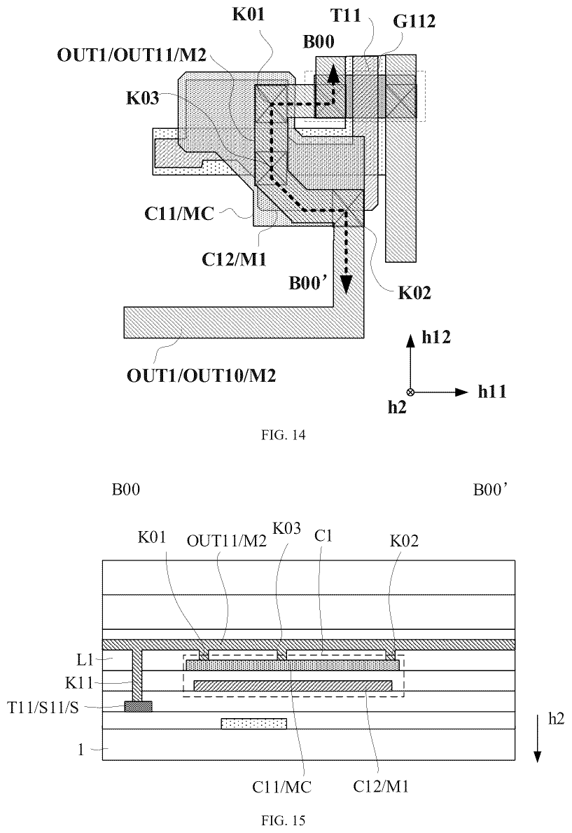

For example, as shown in FIG. 14 and FIG. 15, where FIG. 14 is an enlarged schematic diagram of a first connection portion and a first capacitor provided by an embodiment of the present disclosure, and FIG. 15 is a schematic cross-sectional diagram taken along B00-B00′ in FIG. 14, the first connection portion OUT11 is electrically connected to the first electrode plate C11 through three via holes. In addition to the above-mentioned via hole K01 and via hole K02, the three via holes also include a via hole K03. The via hole K01 and the via hole K02 can be located at both ends of the first connection portion OUT11. Along an extension direction of the first connection portion OUT11, the via hole K03 can be located between the via hole K01 and the via hole K02.

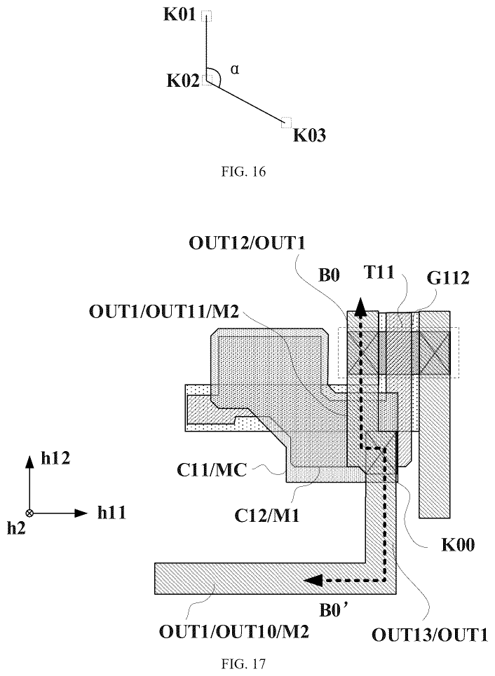

When the first connection portion OUT11 is electrically connected to the first electrode plate C11 of the first capacitor C1 through at least three via holes, in the embodiments of the present disclosure, an included angle α of the connecting lines of the at least three via holes can satisfy α>90°. The connecting lines of the via holes refer to the lines connecting the geometric centers of the via holes. In conjunction with FIG. 16, which is a simplified schematic diagram of the distribution of the three via holes in FIG. 14, Based on this configuration, a plurality of via holes can be disposed as dispersedly as possible in an area where the first capacitor C1 is located, which can improve the space utilization rate of the area where the first capacitor C1 is located and is beneficial to reducing the difficulty of disposing the via holes.

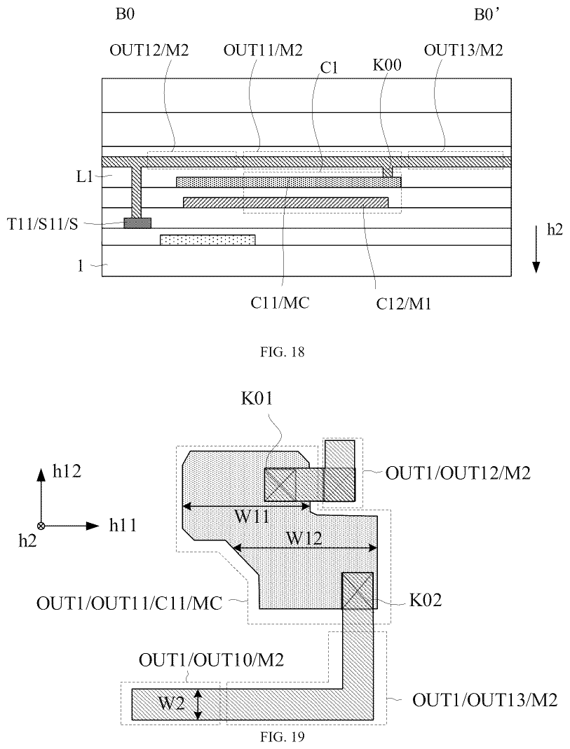

In another possible implementation, as shown in FIG. 17 and FIG. 18, where FIG. 17 is another enlarged schematic diagram of a first connection portion OUT11 and a first capacitor C1 provided by an embodiment of the present disclosure, and FIG. 18 is a schematic cross-sectional diagram taken along B0-B0′ in FIG. 17, the first connection portion OUT11 can also be electrically connected to the first electrode plate C11 of the first capacitor C1 through a via hole K00. As shown in FIG. 17 and FIG. 18, the first connection portion OUT11 and the first connection sub-portion OUT12 are in a same layer and directly connected to each other, and the first connection portion OUT11 and the second connection sub-portion OUT13 are in a same layer and directly connected to each other.

As an example, in the embodiments of the present disclosure, a width of the first connection portion OUT11 in the first direction h11 can be greater than or equal to the line width of at least one other part of the first output line OUT1. The line width of at least one other part of the first output line OUT1 refers to the width of the at least one part of the first output line OUT1 other than the first connection portion OUT11 in the direction perpendicular to the extension direction thereof.

As an example, as shown in FIG. 12, FIG. 14 and FIG. 17, in the embodiments of the present disclosure, the width of the first connection portion OUT11 can be equal to a width of at least one of the main body portion OUT10, the first connection sub-portion OUT12 and the second connection sub-portion OUT13 as an illustration. In this case, the first connection portion OUT11 is a linear structure whose length in its extension direction is significantly greater than its width.

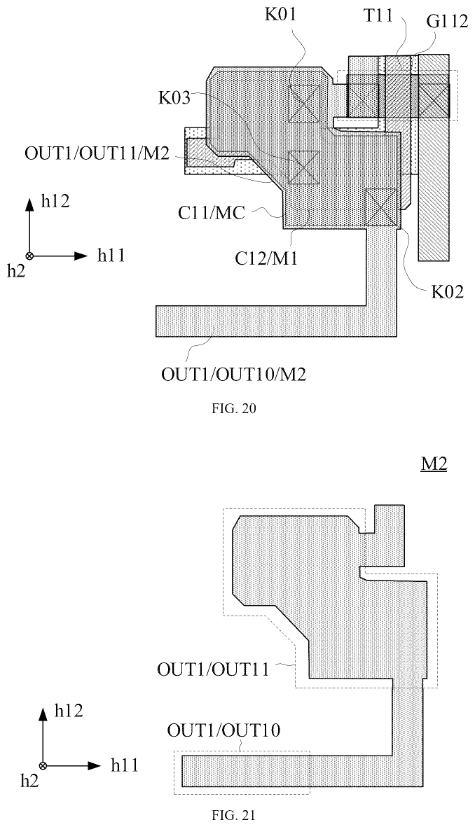

Alternatively, as shown in FIG. 9, FIG. 19, FIG. 20 and FIG. 21, where FIG. 19 is a schematic diagram of a first output line in FIG. 9, FIG. 20 is a further schematic diagram of a further first connection portion and a first capacitor provided by an embodiment of the present disclosure, and FIG. 21 is a schematic diagram of a first output line in FIG. 20, in the embodiments of the present disclosure, the first connection portion OUT11 can also be a planar structure, and the width of the first connection portion OUT11 in the first direction h11 is greater than the line width of at least one other part of the first output line OUT1, such as the main body portion OUT10, the first connection sub-portion OUT12 and the second connection sub-portion OUT13.

With this configuration, in the area where the first capacitor C1 is located, in the embodiments of the present disclosure, the width of the first connection portion OUT11 in the first direction h11 can be set as large as possible to reduce the resistance of the first connection portion OUT11, and in turn reduce the overall resistance of the first output line OUT1 including the first connection portion OUT11. While reducing the signal delay of the first output signal transmitted by the first output line OUT1, the space of the area where the first capacitor C1 is located can be fully utilized.

Optionally, as shown in FIG. 19 and FIG. 21, in the embodiments of the present disclosure, a shape of an orthographic projection of the first connection portion OUT11 onto the plane of the substrate 1 can be set to be the same as a shape of an orthographic projection of at least one electrode plate of the above-mentioned first capacitor C1 onto the plane of the substrate 1.

It should be noted that the widths of different parts of the first connection portion OUT11 in the first direction h11 can be the same or different. FIG. 19 illustrates that the widths of two parts of the first connection portion OUT11 in the first direction h11 are W11 and W12 respectively, and the line width of the main body portion OUT10 is W2, where both W11 and W12 are greater than W2.

Optionally, as shown in FIG. 9, at least part of the main body portion OUT10 can be located in the source-drain metal layer M2 to reduce the resistance of the first output line OUT1, thereby weakening the signal attenuation of the first output signal transmitted by the first output line OUT1 due to the voltage drop during its transmission process.

As an example, as shown in FIG. 3, the driving unit 20 further includes a first isolation transistor T11. The first isolation transistor T11 has a gate connected to the second level signal terminal VGL, a first terminal electrically connected to the first output terminal OUT1, and a second terminal electrically connected to the second output module 42.

When a potential of the gate of the fourth output transistor T32 is coupled to a third level signal lower than a potential of the second level signal provided by the second level signal terminal VGL by a parasitic capacitance, the first isolation transistor T11 can be turned off, which can avoid the third level signal from being transmitted to the first output terminal OUT1, and further avoid a potential of the first output signal output by the first output terminal OUT1 from being affected. This is beneficial to improving the stability of the first output signal. When the first output terminal OUT1 is electrically connected to the first input terminal IN1 of another stage driving unit, the operating stability of the another stage driving unit 20 can be improved.

As shown in FIG. 4, FIG. 9, FIG. 11 and FIG. 12, the above-mentioned first connection portion OUT11 is also configured to connect the first terminal of the first isolation transistor T11 and the second terminal of the third output transistor T22. When the third output transistor T22 is turned on, a first level signal provided by the second level signal connection line VGL can be transmitted to the first terminal of the first isolation transistor T11 through the turned-on third output transistor T22 and the first connection portion OUT11.

Optionally, as shown in FIG. 4, FIG. 9, FIG. 11 and FIG. 12, the first isolation transistor T11 is located between the first output module 41 and the second output module 42, so as to facilitate the connection of the first isolation transistor T11 with the first output module 41 and the second output module 42 respectively.

As an example, as shown in FIG. 9 and FIG. 12, the display panel further includes a second connection portion 52, and the second connection portion 52 connects the second terminal of the first isolation transistor T11 and the second output module 42. Along the direction h2 perpendicular to the plane of the substrate 1, the first output line OUT1 and the second connection portion 52 do not overlap each other, so as to reduce the coupling capacitance therebetween.

Optionally, as shown in FIG. 9 and FIG. 12, along the first direction h11, the first output line OUT1 is at least partially located on one side of the second connection portion 52 away from the second output module 42, so as to facilitate the connection of the first output line OUT1 with the first input terminal IN1 of the next stage driving unit 20, which is beneficial to shortening the length of the first output line OUT1 and reducing the delay of the signal transmitted by the first output line OUT1.

As an example, as shown in FIG. 3, the driving unit 20 further includes a third node N3, a third-node writing unit 203 and the first processing module 21. The third-node writing unit 203 is electrically connected to the third node N3, and the third-node writing unit 203 is configured to electrically connect the first input terminal IN1 and the third node N3 under the control of a first clock signal terminal CK. The first processing module 21 is electrically connected to the first node N1.

The first processing module 21 includes a second capacitor C2 electrically connected to the first node N1 and a first-node writing unit 201. The first-node writing unit 201 includes a first sub-unit 2011, and the first sub-unit 2011 is configured to electrically connect the first level signal terminal VGH and the first node N1 under the control of the third node N3. The second capacitor C2 is configured to electrically connect the second level signal terminal VGH and the first node N1, and the second capacitor C2 improves the stability of a potential of the first node N1.

When the first sub-unit 2011 is disposed, as an example, as shown in FIG. 9 and FIG. 12, along the first direction h11, in the embodiments of the present disclosure, the first sub-unit 2011 and the output module 4 can be located on both sides of the second capacitor C2.

Optionally, as shown in FIG. 9 and FIG. 12, the display panel further includes a third connection portion 53, and the third connection portion 53 connects the first sub-unit 2011 and the output module 4. In particular, the third connection portion 53 can connect an output terminal of the first sub-unit 2011 and the gate of the first output transistor T21. A signal output by the output terminal of the first sub-unit 2011 can be transmitted to the gate of the first output transistor T21 through the third connection portion 53.

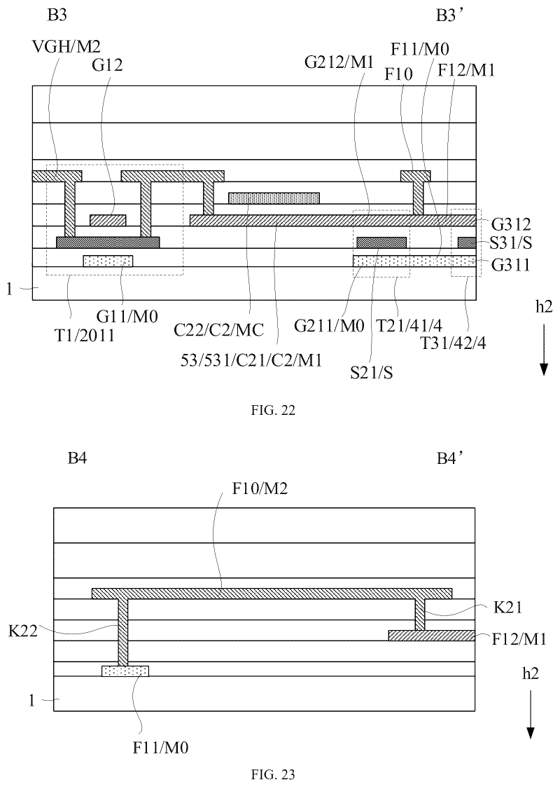

Optionally, as shown in FIG. 9 and FIG. 22, which is a schematic cross-sectional diagram taken along B3-B3′ in FIG. 9, the third connection portion 53 includes a first connection sub-portion 531, and the first connection sub-portion 531 includes the first electrode plate C21 of the second capacitor C2. In other words, the first electrode plate C21 of the second capacitor C2 can be reused as the first connection sub-portion 531. Based on this configuration, there is no need to additionally provide a connection portion for connecting the first sub-unit 2011 and the output module 4, which is beneficial to simplifying the structure of the driving unit 20 and further reducing the area of the driving unit 20.

In the embodiments of the present disclosure, at least one of the first output transistor T21 and the second output transistor T31 includes a top-bottom double-gate structure. FIG. 9 and FIG. 22 illustrate that the first output transistor T21 and the second output transistor T31 each include a top-bottom double-gate structure.

As shown in FIG. 22, the first output transistor T21 includes an active layer S21, as well as a top gate G212 and a bottom gate G211 located on both sides of the active layer S21 in the direction h2 perpendicular to the plane of the substrate 1. The second output transistor T31 includes an active layer S31, as well as a top gate G312 and a bottom gate G311 located on both sides of the active layer S31 in the direction h2 perpendicular to the plane of the substrate 1. The top-bottom double-gate structure can improve the carrier mobility and sub-threshold characteristics of the device.

As an example, as shown in FIG. 22, the semiconductor layer S includes the active layer S21 of the above-mentioned first output transistor T21 and the active layer S31 of the second output transistor T31. The display panel further includes a second gate metal layer M0, and the second gate metal layer M0 is located on one side of the semiconductor layer S close to the substrate 1. The second gate metal layer M0 includes the bottom gate G211 of the above-mentioned first output transistor T21 and the bottom gate G311 of the second output transistor T31, and the first gate metal layer M1 includes the top gate G212 of the above-mentioned first output transistor T21 and the top gate G312 of the second output transistor T31.

Optionally, as shown in FIG. 22, the display panel further includes a first bottom-gate connection portion F11, a first top-gate connection portion F12 and a first gate connection portion F10 disposed in different layers.

Along the direction h2 perpendicular to the plane of the substrate 1, both the first bottom-gate connection portion F11 and the first top-gate connection portion F12 at least partially do not overlap with the active layer S21 of the first output transistor T21, and both the first bottom-gate connection portion F11 and the first top-gate connection portion F12 at least partially do not overlap with the active layer S31 of the second output transistor T31.

In the embodiments of the present disclosure, at least one of the top gate G212 of the first output transistor T21 and the top gate G312 of the second output transistor T31 is disposed in the same layer as and connected to the first top-gate connection portion F12. That is, the first gate metal layer M1 includes the first top-gate connection portion F12.

At least one of the bottom gate G211 of the first output transistor T21 and the bottom gate G311 of the second output transistor T31 is disposed in the same layer as and connected to the first bottom-gate connection portion F11. That is, the second gate metal layer M0 includes the first bottom-gate connection portion F11.

Optionally, as shown in conjunction with FIG. 23, which is a schematic cross-sectional diagram taken along B4-B4′ in FIG. 9, along the direction h2 perpendicular to the plane of the substrate 1, the first gate connection portion F10 is located on one side of the first gate metal layer M1 away from the second gate metal layer M0. FIG. 23 illustrates that the source-drain metal layer M2 includes the first gate connection portion F10. One end of the first gate connection portion F10 is electrically connected to the first top-gate connection portion F12 through the via hole K21, and the other end of the first gate connection portion F10 is electrically connected to the first bottom-gate connection portion F11 through the via hole K22. Based on this configuration, the top gate and the bottom gate of the first output transistor T21 are avoided from being connected directly through via holes penetrating an insulating layer therebetween, which can reduce the requirements for the etching process and the disconnection possibility of the connection portion between the top gate and the bottom gate of the first output transistor T21, which is beneficial to improving the process reliability.

Optionally, as shown in FIG. 9, along the first direction h11, the first gate connection portion F10 is located between the first output transistor T21 and the second output transistor T31. Based on this configuration, the first gate connection portion F10 can be used to connect both the top gate G212 and the bottom gate G211 of the first output transistor T21 and the top gate G312 and the bottom gate G311 of the second output transistor T31. That is, the first gate connection portion F10 can be shared by the first output transistor T21 and the second output transistor T31, which can reduce the number of gate connection portions used to connect the top gate and the bottom gate, which is beneficial to simplifying the structure of the driving unit 20 and reducing the area occupied by the driving unit 20 in the display panel.

As an example, as shown in FIG. 3, the first sub-unit 2011 includes a first transistor T1. The first transistor T1 has a gate electrically connected to the third node N3, as well as a first terminal and a second terminal electrically connected to the first level signal terminal VGH and the first node N1 respectively. When the driving unit 20 operates, under the control of the third node N3, the first transistor T1 is turned on, and the second level signal provided by the first level signal terminal VGH can be written into the first node N1 through the first transistor T1. Optionally, the first transistor T1 includes a P-type transistor.

As an example, as shown in FIG. 9, the above-mentioned third connection portion 53 connects the second terminal of the first transistor T1 and the output module 4.

Optionally, as shown in FIG. 9, the first transistor T1 is located on one side of the second capacitor C2 close to the first level signal connection line VGH to shorten the distance between the first terminal of the first transistor T1 and the first level signal connection line VGH, facilitating their connection.

Optionally, the first transistor T1 includes a top-bottom double-gate structure. As shown in FIG. 9, the display panel further includes a gate connection portion F01, and the gate connection portion F01 is configured to connect a top gate and a bottom gate of the first transistor T1. Optionally, the gate connection portion F01 can be located in the source-drain metal layer M2. Based on this configuration, the top gate and the bottom gate of the first transistor T1 are avoided from being connected directly through via holes penetrating an insulating layer therebetween, which can reduce the requirements for the etching process and the disconnection possibility of the connection portion between the top gate and the bottom gate of the first transistor T1, which is beneficial to improving the process reliability.

As an example, as shown in FIG. 9, the gate connection portion F01 can be located between the second capacitor C2 and the first level signal connection line VGH.

Optionally, as shown in FIG. 9 and FIG. 12, along the second direction h12, the second capacitor C2 and the first capacitor C1 at least partially overlap each other. Along the second direction h12, the second capacitor C2 is located on the side of the first capacitor C1 close to the first level signal connection line VGH to shorten the distance between the second capacitor C2 and the first level signal connection line VGH, facilitating their connection.

As an example, as shown in FIG. 3, the driving unit 20 further includes a fourth node N4. The first processing module 21 further includes a fourth-node writing unit 204 and a third capacitor C3. The fourth-node writing unit 204 is configured to electrically connect the second level signal terminal VGL and the fourth node N4 under the control of the first clock signal terminal CK and electrically connect the first clock signal terminal CK and the fourth node N4 under the control of the third node N3.

As shown in FIG. 3, in addition to the above-mentioned first sub-unit 2011, the first-node writing unit 201 further includes a second sub-unit 2012, and the second sub-unit 2012 is configured to electrically connect a second clock signal terminal CKB and the first node N1 under the control of the fourth node N4.

As shown in FIG. 3, a first electrode plate C31 of the third capacitor C3 is electrically connected to the fourth node N4, and a second electrode plate C32 of the third capacitor C3 is electrically connected to the second sub-unit 2012.

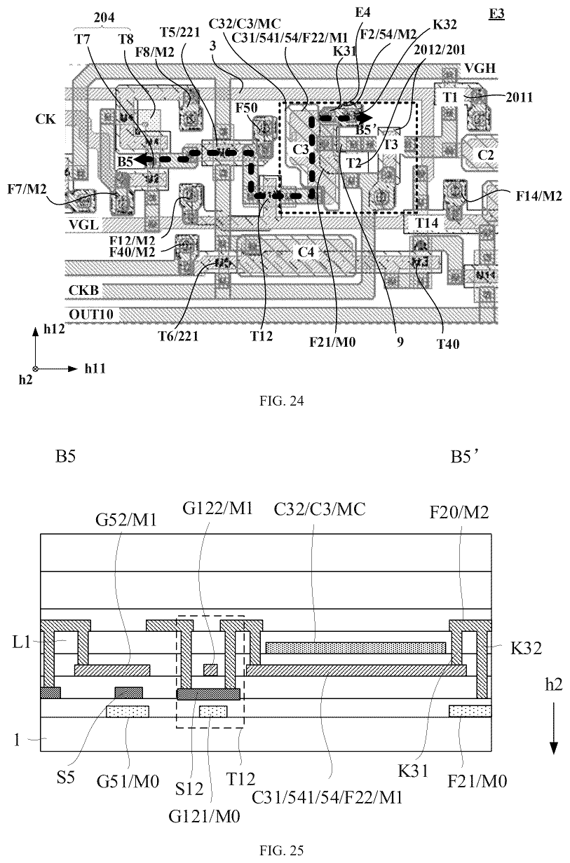

Optionally, as shown in FIG. 24, which is an enlarged schematic diagram of an area E3 in FIG. 4, along the first direction h11, at least part of the above-mentioned fourth-node writing unit 204 and at least part of the second sub-unit 2012 are located on both sides of the third capacitor C3.

Along the first direction h11, the third capacitor C3 is located on one side of the above-mentioned second capacitor C2 away from the first output transistor (not shown in FIG. 24), at least part of the fourth-node writing unit 204 is located on one side of the third capacitor C3 away from the first output transistor, and at least part of the second sub-unit 2012 is located on the side of the third capacitor C3 close to the first output transistor.

Optionally, as shown in FIG. 24, the display panel further includes a fourth connection portion 54, and the fourth connection portion 54 connects the fourth-node writing unit 204 and the second sub-unit 2012.

As an example, as shown in FIG. 24 and FIG. 25, where FIG. 25 is a schematic cross-sectional diagram taken along B5-B5′ in FIG. 24, the fourth connection portion 54 includes a second connection sub-portion 541, and the second connection sub-portion 541 includes the first electrode plate C31 of the third capacitor C3. Based on this configuration, it is equivalent that the first electrode plate C31 of the third capacitor C3 is reused as a connection structure connecting the fourth-node writing unit 204 and the second sub-unit 2012, which is beneficial to simplifying the structure of the driving unit 20.

As an example, as shown in FIG. 3, the second sub-unit 2012 includes a second transistor T2 and a third transistor T3. A gate of the second transistor T2 is electrically connected to the fourth node N4, and a second terminal of the second transistor T2 is electrically connected to a first terminal of the third transistor T3. A first terminal of the second transistor T2 and a gate of the third transistor T3 are both electrically connected to the second clock signal terminal CKB, and a second terminal of the third transistor T3 is electrically connected to the first node N1.

As an example, as shown in FIG. 24, the display panel further includes a second clock signal connection line CKB. At least part of the second clock signal connection line CKB extends along the first direction h11. Along the second direction h12, at least part of the second clock signal connection line CKB is located on one side of the second level signal connection line VGL close to the main body part OUT10 of the first output line OUT1.

Optionally, in the embodiments of the present disclosure, at least one of the second transistor T2 and the third transistor T3 can include a top-bottom double-gate structure to improve the carrier mobility and sub-threshold characteristics of the device.

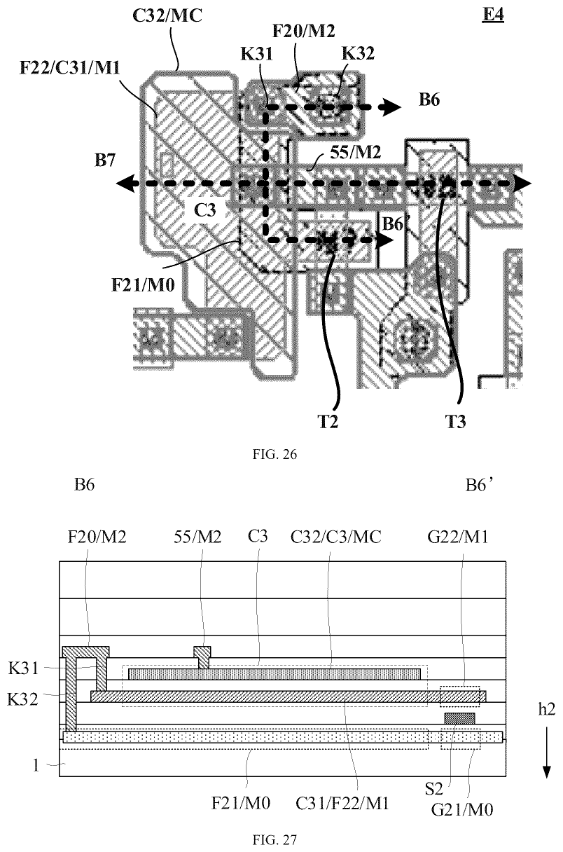

Optionally, as shown in conjunction with FIG. 26 and FIG. 27, where FIG. 26 is an enlarged schematic diagram of an area E4 in FIG. 24, and FIG. 27 is a cross-sectional diagram taken along B6-B6′ in FIG. 26, the display panel further includes a second bottom-gate connection portion F21, a second top-gate connection portion F22, and a second gate connection portion F20. Along the direction h2 perpendicular to the plane of the substrate 1, both the second top-gate connection portion F22 and the second bottom-gate connection portion F21 at least partially do not overlap with the active layer S2 of the second transistor T2.

In the embodiments of the present disclosure, the second bottom-gate connection portion F21 is disposed in a same layer as and connected to a bottom gate G21 of the second transistor T2. That is, the second gate metal layer M0 includes the second bottom-gate connection portion F21. The second top-gate connection portion F22 is disposed in a same layer as and connected to a top gate G22 of the second transistor T2. That is, the first gate metal layer M1 includes the second top-gate connection portion F22.

The second gate connection portion F20 is located on the side of the first gate metal layer M1 away from the second gate metal layer M0. FIG. 26 and FIG. 27 illustrate that the second gate connection portion F20 is located in the source-drain metal layer M2.

As shown in FIG. 26 and FIG. 27, one end of the second gate connection portion F20 is connected to the second top-gate connection portion F22 through a via hole K31, and the other end of the second gate connection portion F20 is connected to the second bottom-gate connection portion F21 through another via hole K32. Based on this configuration, the top gate and the bottom gate of the second transistor T2 are avoided from being connected directly through via holes penetrating an insulating layer therebetween, which can reduce the requirements for the etching process and the disconnection possibility of the connection portion between the top gate and the bottom gate of the second transistor T2, which is beneficial to improving the process reliability.

As shown in FIG. 25 and FIG. 27, the first electrode plate C31 of the third capacitor C3 is located in the first gate metal layer M1, and the second electrode plate of the third capacitor C3 is located in the capacitor metal layer MC.

Optionally, as shown in FIG. 27, the second top-gate connection portion F22 includes the first electrode plate C31 of the third capacitor C3. That is, the first electrode plate C31 of the third capacitor C3 can be reused as a connection structure for connecting the top gate G22 of the second transistor T2 and the second gate connection portion F20. Based on this configuration, the space of an area where the third capacitor C3 is located can be fully utilized, which is beneficial to simplifying the structure of the driving unit 20 and reducing the area occupied by the driving unit 20 in the display panel.

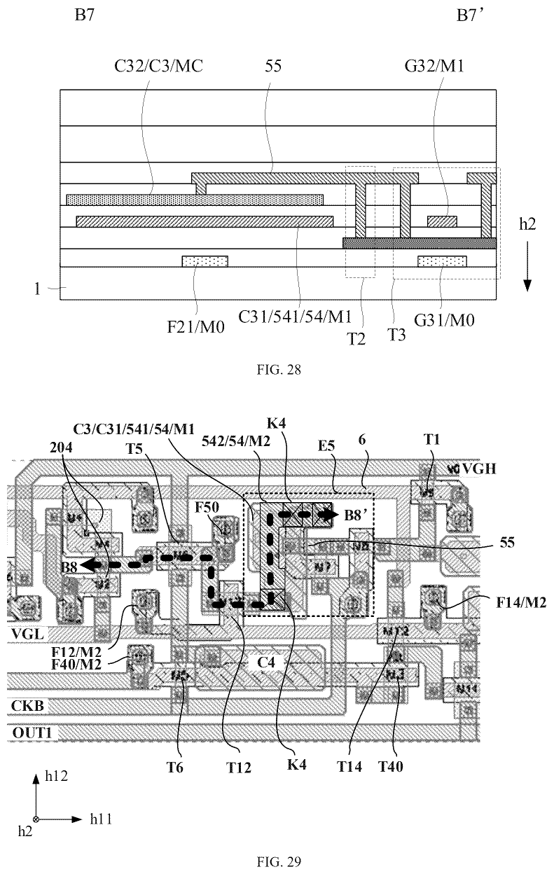

As an example, as shown in FIG. 26, FIG. 27, and FIG. 28, where FIG. 28 is a schematic cross-sectional diagram taken along B7-B7′ in FIG. 26, the display panel further includes a fifth connection portion 55. The fifth connection portion 55 connects the second electrode plate C32 of the third capacitor C3, the first terminal of the third transistor T3, and the second terminal of the second transistor T2. As shown in FIG. 27 and FIG. 28, the fifth connection portion 55 is located on one side of the second electrode plate C32 of the third capacitor C3 away from the substrate 1. FIG. 27 and FIG. 28 illustrate that the fifth connection portion 55 is located in the source-drain metal layer M2.

Optionally, as shown in FIG. 27, in the embodiments of the present disclosure, the fifth connection portion 55 and the second gate connection portion F20 can be disposed in a same layer and spaced from each other to avoid contact between them. As an example, a distance between the fifth connection portion 55 and the second gate connection portion F20 can be set according to the process capability, which is not limited in the embodiments of the present disclosure.

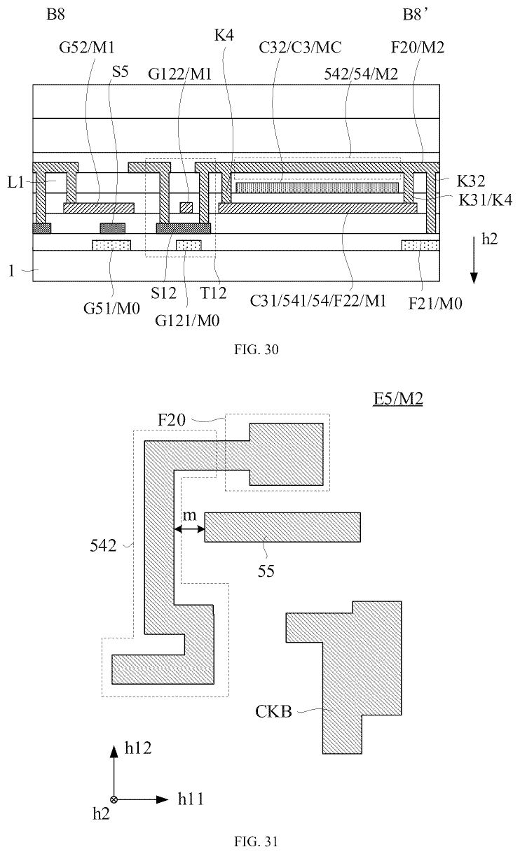

Optionally, as shown in FIG. 29 and FIG. 30, where FIG. 29 is a partial schematic view of the wiring of an further driving unit provided by an embodiment of the present disclosure, and FIG. 30 is a cross-sectional diagram taken along B8-B8′ in FIG. 29, the fourth connection portion 54 further includes a third connection sub-portion 542. Along the direction h2 perpendicular to the plane of the substrate 1, the third connection sub-portion 542 is located on one side of the third capacitor C3 away from the substrate 1. The third connection sub-portion 542 is connected to the first electrode plate C31 of the third capacitor C3 through at least two via holes. The provision of the third connection sub-portion 542 can reduce the resistance of the fourth connection portion 54, thereby reducing the signal delay.

Optionally, as shown in FIG. 31, which is an enlarged schematic diagram of a source-drain metal layer in an area E5 in FIG. 29, in the embodiments of the present disclosure, the above-mentioned third connection sub-portion 542 and the above-mentioned fifth connection portion 55 can be disposed in a same layer and spaced from each other to avoid contact between them. As shown in FIG. 31, there is a distance m between the third connection sub-portion 542 and the fifth connection portion 55. As an example, the distance between the third connection sub-portion 542 and the fifth connection portion 55 can be set according to the process capability, which is not limited in the embodiments of the present disclosure. FIG. 31 illustrates that they are disposed in the same layer and in the source-drain metal layer M2.

As an example, as shown in FIG. 3, the first processing module 21 further includes a second isolation transistor T12. The second isolation transistor T12 has a gate electrically connected to the second level signal terminal VGL, as well as a first terminal and a second terminal electrically connected to the fourth-node writing unit 204 and the first electrode plate C31 of the third capacitor C3 respectively. The second isolation transistor T12 is configured to be turned off when a potential of the first electrode plate C31 of the third capacitor C3 is pulled down to be less than a potential of the first level signal, so as to isolate the connection between the fourth-node writing unit 204 and the first electrode plate C31 of the third capacitor C3 and improve the reliability of the transistors in the fourth-node writing unit 204.

As an example, as shown in FIG. 24 and FIG. 29, along the second direction h12, the second isolation transistor T12 is located on one side of the second level signal connection line VGL close to the first level signal connection line VGH. Moreover, along the first direction h11, the second isolation transistor T12 is located on one side of the third capacitor C3 close to the fourth-node writing unit 204.

As shown in FIG. 24 and FIG. 29, the above-mentioned fourth connection portion 54 is electrically connected to the fourth-node writing unit 204 through the second isolation transistor T12.

Optionally, the second isolation transistor T12 includes a top-bottom double-gate structure. As shown in FIG. 24 and FIG. 29, the display panel further includes a gate connection portion F12, which is configured to connect a top gate and a bottom gate of the second isolation transistor T12. Optionally, the gate connection portion F12 can be located in the source-drain metal layer M2. Based on this configuration, the top gate and the bottom gate of the second isolation transistor T12 are avoided from being connected directly through via holes penetrating an insulating layer therebetween, which can reduce the requirements for the etching process and the disconnection possibility of the connection portion between the top gate and the bottom gate of the second isolation transistor T12, which is beneficial to improving the process reliability.

Optionally, as shown in FIG. 24, FIG. 26 and FIG. 29, a length of the third capacitor C3 in the second direction h12 is greater than or equal to a length of the third capacitor C3 in the first direction h11. Based on this configuration, on the one hand, an area of the third capacitor C3 can be set as large as possible to increase the driving capability of the driving unit 20. On the other hand, the space occupied by the driving unit 20 in the first direction h11 can also be saved, facilitating disposing more devices on both sides of the third capacitor C3 in the first direction h11.

Optionally, as shown in FIG. 3, the fourth-node writing unit 204 includes a seventh transistor T7. The seventh transistor T7 has a gate electrically connected to the first clock signal terminal CK, a first terminal electrically connected to the second level signal terminal VGL, and a second terminal electrically connected to the fourth node N4. The fourth-node writing unit 204 further includes an eighth transistor T8. The eighth transistor T8 has a gate electrically connected to the third node N3, a first terminal electrically connected to the first clock signal terminal CK, and a second terminal electrically connected to the fourth node N4. FIG. 3 illustrates that the eighth transistor T8 includes a double-gate transistor.

As shown in FIG. 24, the display panel further includes a first clock signal connection line CK. Along the second direction h12, the first clock signal connection line CK is located between the first level signal connection line VGH and the second level signal connection line VGL. The seventh transistor T7 is located on one side of the eighth transistor T8 close to the second level signal connection line VGL to shorten a distance between the seventh transistor T7 and the second level signal connection line VGL, facilitating the connection between the first terminal of the seventh transistor T7 and the second level signal connection line VGL.

Optionally, at least one of the seventh transistor T7 and the eighth transistor T8 includes a top-bottom double-gate structure to improve the carrier mobility and sub-threshold characteristics of the device.

As an example, as shown in FIG. 24, the display panel further includes a gate connection portion F7 and a gate connection portion F8. The gate connection portion F7 is configured to connect a top gate and a bottom gate of the seventh transistor T7, and the gate connection portion F8 is configured to connect a top gate and a bottom gate of the eighth transistor T8. Optionally, the gate connection portion F7 and the gate connection portion F8 can be located in the source-drain metal layer M2. Based on this configuration, the top gate and the bottom gate of the seventh transistor T7 are avoided from being connected directly through via holes penetrating an insulating layer therebetween and the top gate and the bottom gate of the eighth transistor T8 are avoided from being connected directly through via holes penetrating an insulating layer therebetween. This can reduce the requirements for the etching process and the disconnection possibility of the connection portions between their top gates and bottom gates, which is beneficial to improving the process reliability.

Optionally, as shown in FIG. 3, the driving unit 20 further includes the second processing module 22, and the second processing module 22 is electrically connected to the second node N2.

As shown in FIG. 3, the second processing module 22 includes a fourth capacitor C4 and a third sub-unit 221. A first electrode plate C41 of the fourth capacitor C4 is electrically connected to the second node N2 with the above-mentioned third-node writing unit 203, and the third sub-unit 221 is electrically connected to a second electrode plate C42 of the fourth capacitor C4.

As an example, as shown in FIG. 24 and FIG. 29, along the second direction h12, the fourth capacitor C4 is located between the second level signal connection line VGL and the main body portion OUT10 of the first output line OUT1. Moreover, the fourth capacitor C4 and the third capacitor C3 at least partially overlap each other in the second direction h12. Moreover, along the first direction h11, the fourth capacitor C4 is located on one side of the second clock signal connection line CKB away from the first capacitor C1.

Optionally, as shown in FIG. 4, along the first direction h11, the third-node writing unit 203 and the first output module 41 are located on both sides of the fourth capacitor C4.

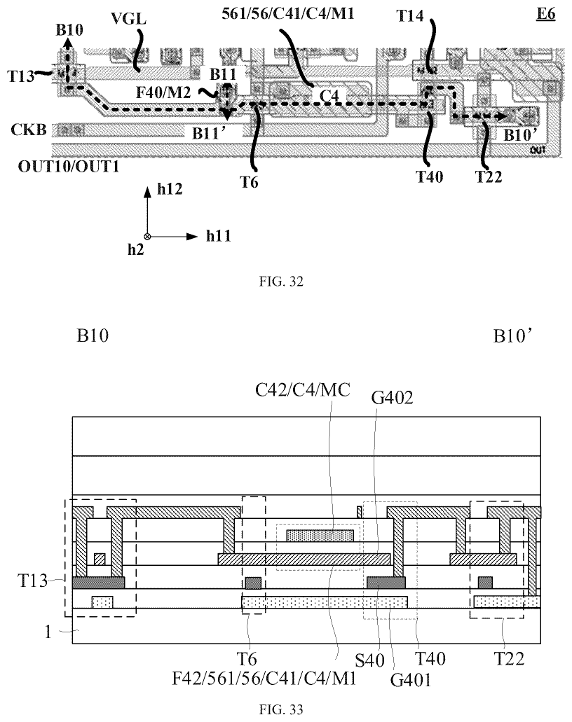

As an example, as shown in FIG. 32 and FIG. 33, where FIG. 32 is an enlarged schematic diagram of an area E6 in FIG. 4, and FIG. 33 is a schematic cross-sectional diagram taken along B10-B10′ in FIG. 32, the display panel further includes a sixth connection portion 56, and the sixth connection portion 56 connects the above-mentioned third-node writing unit and the first output module.

Optionally, as shown in FIG. 32 and FIG. 33, the sixth connection portion 56 includes a fourth connection sub-portion 561, and the fourth connection sub-portion 561 includes the first electrode plate C41 of the fourth capacitor C4. Based on this configuration, the first electrode plate C41 of the fourth capacitor C4 can be reused as a part of the sixth connection portion 56, which can make full use of the space of an area where the fourth capacitor C4 is located and is beneficial to reducing the space occupied by the driving unit 20 in the display panel.

Optionally, as shown in FIG. 3, the second node N2 includes a first sub-node N21 and a second sub-node N22, the first sub-node N21 is electrically connected to the first electrode plate C41 of the fourth capacitor C4, and the second sub-node N22 is electrically connected to the first output module 41.

As shown in FIG. 3, the second processing module 22 further includes an adjusting transistor T40. The adjusting transistor T40 has a gate electrically connected to the first sub-node N21, as well as a first terminal and a second terminal electrically connected to the first sub-node N21 and the second sub-node N22 respectively. When a potential of the first sub-node N21 is less than the potential of the first level signal, for example, when the first sub-node N21 is pulled down to the third level signal under the coupling action of the fourth capacitor C4, the adjusting transistor T40 is turned on, and the third level signal of the first sub-node N21 can be written into the second sub-node N22 through the isolation transistor T40. When the potential of the first sub-node N21 is greater than or equal to the first level signal, the isolation transistor T40 is turned off, so that the second sub-node N22 can be caused to maintain the third level signal. Based on this configuration, a duration for which the second sub-node N22 is at the third level signal can be made longer than a duration for which the first sub-node N21 is at the third level signal, so that the third output transistor T22 can be stably turned on under the control of the second sub-node N22.

Optionally, as shown in FIG. 32, along the first direction h11, the adjusting transistor T40 is located on one side of the fourth capacitor C4 close to the third output transistor T22. Along the second direction h12, the adjusting transistor T40 is located between the second level signal connection line VGL and the main body portion OUT10 of the first output line OUT1.

As shown in FIG. 32, the sixth connection portion 56 is electrically connected to the third output transistor T22 through the adjusting transistor T40.

Optionally, as shown in FIG. 32 and FIG. 33, the adjusting transistor T40 includes a top-bottom double-gate structure to improve the carrier mobility and sub-threshold characteristics of the adjusting transistor T40.

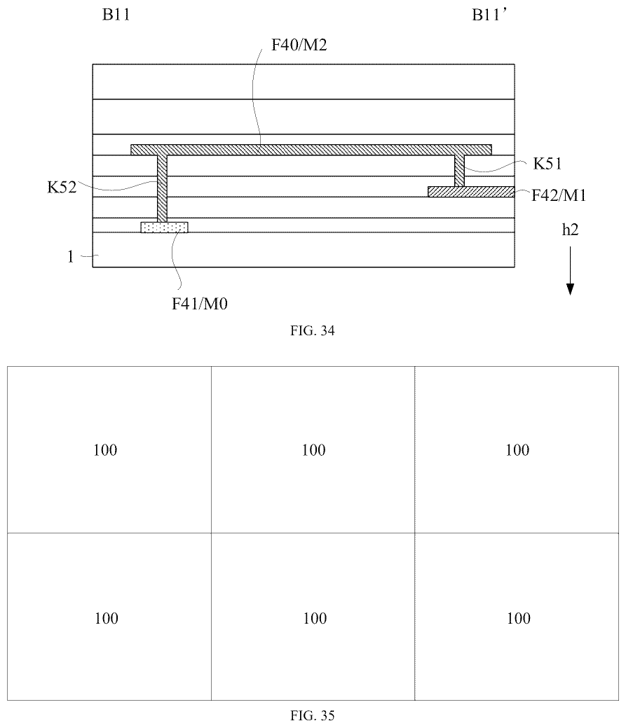

As shown in conjunction with FIG. 34, which is a schematic cross-sectional diagram taken along B11-B11′ in FIG. 32, the display panel further includes a third gate connection portion F40, a third bottom-gate connection portion F41, and a third top-gate connection portion F42 disposed in different layers. Along the direction h2 perpendicular to the plane of the substrate 1, both the third bottom-gate connection portion F41 and the third top-gate connection portion F42 at least partially do not overlap with an active layer (not shown in FIG. 34) of the adjusting transistor.

In the embodiments of the present disclosure, a bottom gate G401 of the adjusting transistor T40 is disposed in a same layer as and connected to the third bottom-gate connection portion F41. That is, the second gate metal layer M0 includes the third bottom-gate connection portion F41. A top gate G402 of the adjusting transistor T40 is disposed in a same layer as and connected to the third top-gate connection portion F42. That is, the first gate metal layer M1 includes the third top-gate connection portion F42.

The third gate connection portion F40 is located on the side of the first gate metal layer M1 away from the second gate metal layer M0. FIG. 34 illustrates that the source-drain metal layer M2 includes the third gate connection portion F40.

Optionally, one end of the third gate connection portion F40 is connected to the third bottom-gate connection portion F41 through a via hole K52, and the other end of the third gate connection portion F40 is connected to the third top-gate connection portion F42 through another via hole K51. Based on this configuration, the top gate and the bottom gate of the adjusting transistor T40 are avoided from being directly connected through via holes penetrating an insulating layer therebetween, which can reduce the requirements for the etching process and the disconnection possibility of the connection portion between the top gate and the bottom gate of the adjusting transistor T40, which is beneficial to improving the process reliability.

As an example, as shown in FIG. 32, along the first direction h11, the third gate connection portion F40 is located on one side of the fourth capacitor C4 away from the isolation transistor T40. Along the second direction h12, the third gate connection portion F40 is located between the second level signal connection line VGL and the second clock signal connection line CKB. Based on this configuration, the space on the side of the fourth capacitor C4 away from the isolation transistor T40 can be fully utilized, which is beneficial to reducing the difficulty of disposing the third gate connection portion F40.

Optionally, as shown in FIG. 33, the third top-gate connection portion F42 includes the first electrode plate C41 of the fourth capacitor C4. That is, the first electrode plate C41 of the fourth capacitor C4 can be reused as a connection structure connecting the top gate G402 of the adjusting transistor T40 and the third gate connection portion F40. Based on this configuration, the space of the area where the fourth capacitor C4 is located can be fully utilized, which is beneficial to simplifying the structure of the driving unit 20 and reducing the area occupied by the driving unit 20 in the display panel.

Optionally, as shown in FIG. 3, the second processing module 22 further includes a third isolation transistor T13. The third isolation transistor T13 has a gate electrically connected to the second level signal terminal VGL, as well as a first terminal and a second terminal electrically connected to the third-node writing unit 203 and the second node N2 respectively. As shown in FIG. 2, when the second node N2 is divided into the first sub-node N21 and the second sub-node N22, the second terminal of the third isolation transistor T13 can be electrically connected to the first sub-node N21.

When the fourth capacitor C4 couples the potential of the first sub-node N21 to be lower than a potential of the second level signal terminal VGL, for example, when the potential of the first sub-node N21 is coupled to the third level signal, the third isolation transistor T13 is turned off, which can avoid the third level signal of the first sub-node N21 from affecting the reliability of the transistors in the third-node writing unit 203.

Optionally, the third isolation transistor T13 includes a P-type transistor.

As shown in FIG. 32, the above-mentioned sixth connection portion 56 is electrically connected to the third-node writing unit (not shown in FIG. 32) through the third isolation transistor T13.

Optionally, as shown in FIG. 3, the third-node writing unit 203 includes a fourth transistor T4. The fourth transistor T4 has a gate electrically connected to the first clock signal terminal CK, a first terminal electrically connected to the first input terminal IN1, and a second terminal electrically connected to the third isolation transistor T13.

Optionally, as shown in FIG. 3, the third sub-unit 221 includes a fifth transistor T5. The fifth transistor T5 has a gate electrically connected to the fourth node N4, a first terminal electrically connected to the first level signal terminal VGH, and a second terminal electrically connected to the second electrode plate C42 of the fourth capacitor C4. The third sub-unit 221 further includes a sixth transistor T6. The sixth transistor T6 has a gate electrically connected to the first electrode plate C41 of the fourth capacitor C4, a first terminal electrically connected to the second clock signal terminal CKB, and a second terminal electrically connected to the second electrode plate C42 of the fourth capacitor C4.

As an example, the fifth transistor T5 and the sixth transistor T6 include P-type transistors.

As an example, as shown in FIG. 24 and FIG. 29, the sixth transistor T6 and the fourth capacitor C4 are arranged along the first direction h11, and the sixth transistor T6 is located on one side of the fourth capacitor C4 away from the adjusting transistor T40. Along the second direction h12, the sixth transistor T6 is located between the second level signal connection line VGL and the second clock signal connection line CKB to shorten a distance between the sixth transistor T6 and the second clock signal connection line CKB, facilitating their connection.

Continuing to refer to FIG. 24 and FIG. 29, the fifth transistor T5 and the sixth transistor T6 are arranged along the second direction h12, and along the second direction h12, the fifth transistor T5 is located on one side of the sixth transistor T6 close to the first level signal connection line VGH to shorten a distance between the first terminal of the fifth transistor T5 and the first level signal connection line VGH, facilitating their connection.

As an example, as shown in FIG. 24, FIG. 29 and FIG. 32, the gate of the sixth transistor T6 is connected to the gate of the third output transistor T22 through the first electrode plate C41 of the fourth capacitor C4. That is, the first electrode plate C41 of the fourth capacitor C4 can also be reused as a connection portion between the gate of the sixth transistor T6 and the gate of the third output transistor T22. Based on this configuration, the wiring structure of the driving unit 20 can be simplified, which is beneficial to further reducing the area occupied by the driving unit 20 in the display panel.

As an example, the fifth transistor T5 includes a top-bottom double-gate structure to improve the carrier mobility and sub-threshold characteristics of the fifth transistor T5.

As shown in FIG. 24 and FIG. 29, the display panel further includes a gate connection portion F50, and the gate connection portion F50 connects a top gate and a bottom gate of the fifth transistor T5. Based on this configuration, the top gate and the bottom gate of the fifth transistor T5 are avoided from being directly connected through via holes penetrating an insulating layer therebetween, which can reduce the requirements for the etching process and the disconnection possibility of the connection portion between the top gate and the bottom gate, which is beneficial to improving the process reliability.

As an example, the gate connection portion F50 and the third capacitor C3 are arranged along the first direction h11.

Optionally, the sixth transistor T6 includes a top-bottom double-gate structure to improve the carrier mobility and sub-threshold characteristics of the sixth transistor T6.

As shown in FIG. 24, FIG. 29 and FIG. 32, the above-mentioned third gate connection portion F40 is also configured to connect a top gate and a bottom gate of the sixth transistor T6. That is, the third gate connection portion F40 can be shared by the adjusting transistor T40 and the sixth transistor T6, which can reduce the number of gate connection portions used to connect the top gate and the bottom gate, which is beneficial to simplifying the structure of the driving unit 20 and reducing the area occupied by the driving unit 20 in the display panel.

Optionally, as shown in FIG. 3, the driving unit 20 further includes a fourth isolation transistor T14. The fourth isolation transistor T14 has a gate electrically connected to the second level signal terminal VGL, as well as a first terminal and a second terminal electrically connected to the third node N3 and the second node N2 respectively.

As shown in FIG. 22, FIG. 24, FIG. 29 and FIG. 32, the fourth isolation transistor T14 includes a top-bottom double-gate structure to improve the carrier mobility and sub-threshold characteristics of the fourth isolation transistor T14.

As shown in FIG. 3, FIG. 22, FIG. 24 and FIG. 29, the display panel further includes a gate connection portion F14, and the gate connection portion F14 is configured to connect a top gate and a bottom gate of the fourth isolation transistor T14. Optionally, the fourth isolation transistor T14 can be located in the source-drain metal layer M2. Based on this configuration, the top gate and the bottom gate of the fourth isolation transistor T14 are avoided from being directly connected through via holes penetrating an insulating layer therebetween, which can reduce the requirements for the etching process and the disconnection possibility of the connection portion between the top gate and the bottom gate, which is beneficial to improving the process reliability.

As an example, the above-mentioned first isolation transistor T11 can also include a top-bottom double-gate structure to improve the carrier mobility and sub-threshold characteristics of the first isolation transistor T11.

Optionally, the above-mentioned gate connection portion F14 can also connect a bottom gate and a top gate of the first isolation transistor T11. Based on this configuration, the above-mentioned gate connection portion F14 can be reused as a connection portion connecting the top gate and the bottom gate of the first isolation transistor T11. That is, the gate connection portion F14 can be shared by the fourth isolation transistor T14 and the first isolation transistor T11, which can reduce the number of gate connection portions used to connect the top gate and the bottom gate, which is beneficial to simplifying the structure of the driving unit 20 and reducing the area occupied by the driving unit 20 in the display panel.

Optionally, as shown in FIG. 4, a length of the fourth capacitor C4 in the first direction h11 is greater than or equal to a length of the fourth capacitor C4 in the second direction h12. Based on this configuration, on the one hand, an area of the fourth capacitor C4 can be set as large as possible to increase the driving capability of the driving unit 20. On the other hand, the space occupied by the fourth capacitor C4 in the second direction h12 can also be reduced, facilitating disposing more devices on both sides of the fourth capacitor C4 in the second direction h12.

As an example, as shown in FIG. 4, along the second direction h12, the fourth capacitor C4 and the third capacitor C3 at least partially overlap each other.

As an example, as shown in FIG. 4, in the embodiments of the present disclosure, the fourth output transistor T32 and the second output transistor T31 can be arranged along the second direction h12, and the fourth output transistor T32 is located on one side of the second output transistor T31 close to the first output line OUT1.

Optionally, as shown in FIG. 3, the second output module 42 further includes a fifth capacitor C5 electrically connected to the first control signal output terminal OUT2 and the gate of the fourth output transistor T32. During the process of the first output terminal OUT1 outputting an enable level to control the fourth output transistor T32 to be turned on, when a potential of the first control signal output terminal OUT2 jumps from a high-level signal to a low-level signal, under the action of the fifth capacitor C5, a potential of the gate of the fourth output transistor T32 will be coupled to a signal lower than the potential of the first level signal provided by the second level signal terminal VGL, thereby be capable of enhancing the turn-on capability of the fourth output transistor T32.

Optionally, as shown in FIG. 4, the display panel further includes a first input line IN1, and the first input line IN1 is electrically connected to the first input terminal IN1 of the driving unit 20 at the current stage. As an example, along the second direction h12, at least part of the first input line IN1 is located on one side of the first clock signal connection line CK close to the first level signal connection line VGH.

As an example, for any one of the first stage driving unit 20 to the (N−1)-th stage driving unit 20, the first output line OUT1 electrically connected to the first output terminal OUT1 of a corresponding driving unit 20 can be reused as the first input line IN1 electrically connected to the first input terminal IN1 of the next stage driving unit 20. That is to say, one end of the first output line OUT1_i is connected to the first output terminal OUT1 of the driving unit 20_i, and the other end of the first output line OUT1_i is connected to the first input terminal IN1 of the driving unit 20_i+1, where i is an integer, and 1≤i≤N−1.

Optionally, as shown in FIG. 2, the driving unit 20 includes at least two third-node writing units 203, where one third-node writing units 203 is electrically connected to the first processing module 21, and the other third-node writing units 203 is electrically connected to the second processing module 22. Based on this configuration, it is possible to avoid the potential disturbance of the second node N2 from affecting the operating stability of the first processing module 21. FIG. 3 uses 203_1 and 203_2 to distinguish the third-node writing unit electrically connected to the first processing module 21 from the third-node writing unit electrically connected to the second processing module 22, and uses T4_1 and T4_2 to distinguish the fourth transistor electrically connected to the first processing module 21 from the fourth transistor electrically connected to the second processing module 22.

Optionally, as shown in FIG. 4, at least two third-node writing units 203 are disposed adjacent to each other, and the fourth transistor T4_1 and the fourth transistor T4_2 can be disposed adjacent to each other along the first direction h11. Based on this configuration, distances between the two fourth transistors and the first input line IN1 can be shortened, facilitating the connection between the first input line IN1 and the two fourth transistors.

Optionally, as shown in FIG. 4, the display panel further includes a first control signal input line IN21, a second control signal input line IN22, and a first control signal output line OUT2. The first control signal output line OUT2 is connected to the first electrode plate of the fifth capacitor C5 and the second terminal of the fourth output transistor T32 respectively.

Optionally, as shown in FIG. 3, the driving unit 20 further includes a reset transistor T50. The reset transistor T50 has a gate electrically connected to a reset control signal terminal RST, as well as a first terminal and a second terminal electrically connected to the first level signal terminal VGH and the third node N3 respectively.

As an example, as shown in FIG. 4, along the first direction h11, the reset transistor T50 is located between the fourth transistor T4 and the seventh transistor T7. Moreover, along the second direction h12, the reset transistor T50 is located between the fourth transistor T4 and the second level signal connection line VGL.

As shown in FIG. 4, the display panel further includes a reset control connection line RST. Along the second direction h12, the reset control connection line RST is located between the first clock signal connection line CK and the second level signal connection line VGL.

As an example, as shown in FIG. 4, the display panel further includes a third-node connection line 6. The third-node connection line 6 is located on one side of the first level signal connection line VGH close to the third capacitor C3. The third-node connection line 6 is connected to the second terminal of the above-mentioned fourth transistor T4_1, the gate of the eighth transistor T8, and the first terminal of the fourth isolation transistor T14 respectively. Optionally, the third-node connection line 6 can be located in the first gate metal layer M1.

As an example, as shown in FIG. 4, the driving unit 20 includes a first region D1 and a second region D2 arranged along the second direction h12. The first region D1 includes at least part of the above-mentioned first processing module 21, and the second region D2 includes at least part of the above-mentioned second processing module 22. Based on this configuration, the first processing module 21 and the second processing module 22 can be disposed in different regions as much as possible, which is beneficial to increasing the distance between different structures in the first processing module 21 and the second processing module 22 and weakening the coupling.

As shown in FIG. 4, the first region D1 includes a first sub-region D11, a second sub-region D12, and a third sub-region D13 arranged along the first direction h11. The third sub-region D13 is located on one side of the second sub-region D12 away from the first sub-region D11. the first sub-region D11 includes the third-node writing unit 203 and the fourth-node writing unit 204, the second sub-region D12 includes the third capacitor C3 and the second sub-unit 2012, and the third sub-region D13 includes the second capacitor C2 and the first sub-unit 2011. Based on this configuration, it is beneficial to reducing a width of the driving unit 20 in the second direction h12.

As an example, as shown in FIG. 1, the display panel includes a display area AA, and the display area AA includes the above-mentioned pixel circuit 3. Optionally, as shown in FIG. 1, in the embodiments of the present disclosure, the driving unit 20 can be disposed in the display area AA. As an example, as shown in FIG. 1, along the second direction h12, in the embodiments of the present disclosure, the driving unit 20 can be located between two adjacent circuit units 30. The circuit units 30 each include at least one pixel circuit 3. FIG. 1 illustrates that the circuit units 30 each include three pixel circuits 3. Based on this configuration, there is no need to additionally provide an area for accommodating the driving circuit 2 at the periphery of the display area AA, and a borderless design of the display panel can be realized. When a plurality of display panels are spliced to form a large-screen display apparatus with a larger size, the visibility of a splicing seam between two adjacent display panels can be weakened or even eliminated, and the visual effect of the large-screen display apparatus can be improved.

When the above-mentioned first output module 41 and the second output module 42 are provided, as an example, as shown in FIG. 4, in the embodiments of the present disclosure, the first output module 41 and the second output module 42 can be arranged along the first direction h11 to fully utilize the width space where a plurality of pixel circuits 3 are located and reduce a length of the driving unit 20 in the second direction h12.

Optionally, as shown in FIG. 4, a length of the driving unit 20 in the first direction h11 is d1, and the length of the driving unit 20 in the second direction h12 is d2, where d1>d2.

As an example, as shown in FIG. 4, the first input line IN1 includes a first extension portion IN11 extending along the second direction h12, and the second control signal input line IN22 includes a second extension portion IN221 extending along the second direction h12. The length of the above-mentioned driving unit 20 in the first direction h11 can be a distance between the first extension portion IN11 and the second extension portion IN221. The length of the driving unit 20 in the second direction h12 can be a distance between the first level signal connection line VGH and the main body portion OUT10 of the first output line OUT1 in the second direction h12.

As an example, as shown in FIG. 2, the display panel further includes a first clock line C1 and a second clock line C2. The first clock line C1 is electrically connected to the first clock signal terminal CK of an odd-numbered stage driving units 20 and to the second clock signal terminal CKB of an even-numbered stage driving units 20. The second clock line C1 is electrically connected to the second clock signal terminal CKB of the odd-numbered stage driving units 20 and to the first clock signal terminal CK of the even-numbered stage driving units 20.

Based on the same inventive concept, an embodiments of the present disclosure further provides a display apparatus. As shown in FIG. 35, which is a schematic diagram of a display apparatus provided by the embodiment of the present disclosure, the display apparatus includes the above-mentioned display panel 100.

As an example, as shown in FIG. 35, the display apparatus includes a spliced display apparatus. The spliced display apparatus includes at least two display panels 100 mentioned above to be suitable for a large-screen display apparatus with a display function, such as borderless spliced display apparatus.

As an example, this type of spliced display apparatus can be applied in public information display (PID) scenarios such as stations and airports. When the spliced display apparatus includes the above-mentioned display panel 100, the area occupied by the driving circuit can be reduced, thereby achieving a seamless/borderless splicing effect of the spliced display apparatus.

The above descriptions are only preferred embodiments of the present disclosure and are not intended to limit the present disclosure. Any modifications, equivalent replacements, improvements, etc. made within the spirit and principle of the present disclosure shall be included in the protection scope of the present disclosure.

Finally, it should be noted that the above embodiments are only used to illustrate the technical solutions of the present disclosure, not to limit them. Although the present disclosure has been described in detail with reference to the foregoing embodiments, those skilled in the art should understand that they can still modify the technical solutions described in the foregoing embodiments, or make equivalent replacements for some or all of the technical features. However, these modifications or replacements do not make the essence of the corresponding technical solutions deviate from the scope of the technical solutions of the embodiments of the present disclosure.

What is claimed is:

1. A display panel, comprising:
a substrate; and
a driving circuit and a first output line located on one side of the substrate, wherein
at least part of the first output line extends along a first direction;
the driving circuit comprises a plurality of driving units disposed in cascade, the plurality of driving units are arranged along a second direction, and the second direction intersects with the first direction;
at least one driving unit of the plurality of driving units comprises a first output terminal and an output module, the first output line is connected to the first output terminal of the driving unit at a current stage, the output module comprises a first capacitor, and the first capacitor is electrically connected to the first output terminal; and
along a direction perpendicular to a plane of the substrate, the first output line at least partially overlaps with at least one electrode plate of the first capacitor.

2. The display panel according to claim 1, further comprising a pixel circuit, wherein the pixel circuit receives a first control signal; and
the at least one driving unit further comprises a first control signal output terminal, and the first control signal output terminal is configured to output the first control signal under the control of the first output terminal.

3. The display panel according to claim 2, wherein
the output module comprises a first output module and a second output module;
the first output module electrically connects the first output terminal and a first level signal terminal in response to a signal of a first node and electrically connects the first output terminal and a second level signal terminal in response to a signal of a second node; and
the second output module electrically connects the first control signal output terminal and a first control signal input terminal in response to the signal of the first node, and electrically connects the first control signal output terminal and a second control signal input terminal in response to a signal of the first output terminal.

4. The display panel according to claim 3, wherein
the pixel circuit comprises a pulse width modulation module and a pulse amplitude modulation module, and the pulse width modulation module receives a sweep signal;
the first control signal comprises the sweep signal;
the first control signal input terminal comprises a constant signal terminal; and
the second control signal input terminal comprises a sweep input signal terminal.

5. The display panel according to claim 1, wherein the first output line comprises a first connection portion, along the direction perpendicular to the plane of the substrate, the first connection portion overlaps with the at least one electrode plate of the first capacitor, and the first connection portion is located on one side of the at least one electrode plate of the first capacitor away from the substrate.

6. The display panel according to claim 5, wherein a first electrode plate of the first capacitor is electrically connected to the first output terminal, the first connection portion is located on one side of the first electrode plate away from the substrate, and the first connection portion is electrically connected to the first electrode plate through a via hole.

7. The display panel according to claim 6, wherein the first connection portion is electrically connected to the first electrode plate through at least two via holes, and two via holes of the at least two via holes are spaced apart from each other.

8. The display panel according to claim 5, wherein a first electrode plate of the first capacitor is electrically connected to the first output terminal, a second electrode plate of the first capacitor is electrically connected to a second level signal terminal, the first electrode plate is located on one side of the second electrode plate away from the substrate, and at least part of the first electrode plate is reused as the first connection portion.

9. The display panel according to claim 5, wherein a width of the first connection portion in the first direction is greater than a line width of at least one other part of the first output line.

10. The display panel according to claim 3, wherein
the at least one driving unit further comprises a first isolation transistor;
the first isolation transistor has a gate connected to the second level signal terminal, a first terminal connected to the first output line, and a second terminal electrically connected to the second output module.

11. The display panel according to claim 10, further comprising:
a second connection portion connecting the second terminal of the first isolation transistor and the second output module; and
along the direction perpendicular to the plane of the substrate, the first output line and the second connection portion do not overlap each other.

12. The display panel according to claim 11, wherein
along the first direction, at least part of the first output line is located on one side of the second connection portion away from the second output module.

13. The display panel according to claim 3, wherein
the at least one driving unit further comprises:
a first input terminal;
a third node;
a third-node writing unit configured to electrically connect the first input terminal and the third node under the control of a first clock signal terminal; and
a first processing module electrically connected to the first node, wherein the first processing module comprises a second capacitor and a first-node writing unit, the first-node writing unit comprises a first sub-unit, and the first sub-unit is configured to electrically connect the first level signal terminal and the first node under the control of the third node.

14. The display panel according to claim 13, further comprising:
a third connection portion connecting the first sub-unit and the output module.

15. The display panel according to claim 14, wherein
the third connection portion comprises a first connection sub-portion, and the first connection sub-portion comprises a first electrode plate of the second capacitor.

16. The display panel according to claim 14, wherein
the first output module comprises a first output transistor having a gate electrically connected to the first node;
the second output module comprises a second output transistor having a gate electrically connected to the first node; and
at least one of the first output transistor and the second output transistor comprises a top-bottom double-gate structure.

17. The display panel according to claim 16, further comprising a first gate connection portion, a first bottom-gate connection portion and a first top-gate connection portion disposed in different layers;
wherein a bottom gate of at least one of the first output transistor and the second output transistor is disposed in a same layer as and connected to the first bottom-gate connection portion;
a top gate of at least one of the first output transistor and the second output transistor is disposed in a same layer as and connected to the first top-gate connection portion; and
one end of the first gate connection portion is electrically connected to the first bottom-gate connection portion through a via hole, and the other end of the first gate connection portion is electrically connected to the first top-gate connection portion through another via hole.

18. The display panel according to claim 14, wherein
the first sub-unit comprises a first transistor having a gate electrically connected to the third node, and a first terminal and a second terminal electrically connected to the first level signal terminal and the first node respectively; and
the third connection portion connects the first transistor and the output module.

19. The display panel according to claim 13, wherein
along the second direction, the second capacitor and the first capacitor at least partially overlap each other.

20. A display apparatus, comprising a display panel, wherein the display panel comprises:
a substrate; and
a driving circuit and a first output line located on one side of the substrate, wherein
at least part of the first output line extends along a first direction;
the driving circuit comprises a plurality of driving units disposed in cascade, the plurality of driving units are arranged along a second direction, and the second direction intersects with the first direction;
at least one driving unit of the plurality of driving units comprises a first output terminal and an output module, the first output line is connected to the first output terminal of the driving unit at a current stage, the output module comprises a first capacitor, and the first capacitor is electrically connected to the first output terminal; and
along a direction perpendicular to a plane of the substrate, the first output line at least partially overlaps with at least one electrode plate of the first capacitor.
